(19) United States
(12) Patent Application Publication
(10) Pub. No.: US 2008/0155496 A1
(43) Pub. Date: Jun. 26, 2008

(54) PROGRAM FOR PROCESSOR CONTAINING PROCESSOR ELEMENTS, PROGRAM GENERATION METHOD AND DEVICE FOR GENERATING THE PROGRAM, PROGRAM EXECUTION DEVICE, AND RECORDING MEDIUM

(76) Inventors: Fumihiro Hatano, Osaka (JP); Akira Tanaka, Osaka (JP)

Correspondence Address: MCDERMOTT WILL & EMERY LLP, 600 13TH STREET, NW, WASHINGTON, DC, 20005-3096, US

(21) Appl. No.: 11/957,749

(22) Filed: Dec. 17, 2007

(30) Foreign Application Priority Data
Dec. 22, 2006 (JP) 2006-346715

(51) Int. Cl. G06F 9/315; G06F 9/44

(52) U.S. Cl. 717/106; 712/215; 712/E09.034

(57) ABSTRACT

A program for execution by a computer that includes a plurality of processor elements, the program comprising: a parallel execution program part to assign the plurality of processor elements one-to-one to a plurality of program parts so that the plurality of program parts are executed in parallel with each other; an execution history obtaining part to obtain and hold an execution history of each of the plurality of program parts; a parallel execution judgment part to judge whether or not to execute the plurality of program parts in parallel with each other, in accordance with the obtained execution history; and a processor element assignment control part to perform a control to determine whether to assign the plurality of processor elements to the plurality of program parts, depending on a result of the judgment made by the parallel execution judgment part.

### BACKGROUND OF THE INVENTION

(1) Field of the Invention

The present invention relates to a technology of generating a program for execution by a processor (computer) that has a plurality of processor elements, and especially to generating optimized program.

(2) Description of the Related Art

Among technologies for generating an execution program for execution by a computer that can execute two or more instructions in parallel with each other, known is a technology disclosed in Japanese Patent Application No. 2004-341236, for, especially, arranging instructions in parallel in a predetermined section that follows a conditional branch instruction.

According to Japanese Patent Application No. 2004-341236, information of each execution path (hereinafter merely referred to as path) included in a predetermined section, which follows a conditional branch instruction, is obtained from a source program that contains the conditional branch instruction. Information of the execution frequency for each path is also obtained by executing an execution program using typical data, where the execution program is generated by converting the source program into an execution format. Hereinafter, this method is referred to as a profiling.

According to this technology, one or more paths that have high values of execution frequency as a whole are selected based on the obtained execution frequency information. Then, the instruction groups contained in each of the selected paths are optimized. And generated is an execution program that assigns different processor elements to code sequences of the optimized instruction groups and to a code sequence of all instructions contained in the source program, and the generated execution program is executed. With this structure, the execution time of the selected paths with high execution frequency is reduced since the instruction groups of the selected paths have been optimized, and thus the processing speed of the program including the conventional branch instruction is increased as a whole.

However, in general, the execution frequency of each path is not constant during the entire period in which the program is executed. For example, the execution frequencies for the starting, middle, and ending periods of the entire execution period may be different from an execution frequency for the entire execution period that is obtained by the profiling or the like.

In such a case, when processor elements are assigned to paths that have high execution frequencies according to information of a certain execution frequency that was set for the entire execution period of the program, the processor elements are not efficiently used during execution periods whose execution frequencies are different from the certain execution frequency.

### SUMMARY OF THE INVENTION

The object of the present invention is therefore to provide a program that includes a branch instruction, and makes it possible to use processor elements efficiently even if the execution frequency of each path is not constant during the entire execution period of the program.

The above object is fulfilled by a program 1310 for execution by a computer 1300 that includes a plurality of processor elements, the program comprising: a parallel execution program part 1350 to assign the plurality of processor elements one-to-one to a plurality of program parts so that the plurality of program parts are executed in parallel with each other; an execution history obtaining part 1320 to obtain and hold an execution history of each of the plurality of program parts; a parallel execution judgment part 1330 to judge whether or not to execute the plurality of program parts in parallel with each other, in accordance with the obtained execution history; and a processor element assignment control part 1340 to perform a control to determine whether to assign the plurality of processor elements to the plurality of program parts, depending on a result of the judgment made by the parallel execution judgment part.

In the above-described program, the parallel execution program part 1350 may further include: a first program part that includes a branch instruction and a plurality of execution paths caused by the branch instruction; and a second program part that is repeatedly executed in parallel with the first program part, and includes (i) a block that has a process content that is equivalent with a process content of a part of a certain execution path, among the plurality of execution paths, that does not include the branch instruction, the block of the second program part having a smaller execution time than the part of the certain execution path, (ii) a block that judges whether or not a condition for executing the certain execution path is satisfied, and (iii) a block that controls, when it is judged that the condition is satisfied with respect to a repetitive execution unit, to process a next repetitive execution unit together with the first program part, wherein the execution history obtaining part is included in at least one of the first program part and the second program part.

With the above-stated structures where the execution history obtaining part obtains an execution history of a program part when the program is executed, and holds the execution history, and parallel execution judgment part judges whether or not to execute the first and second program parts in parallel with each other, in accordance with the obtained execution history, the processor element assignment control part can assign the processor elements to the plurality of program parts, based on the execution history that may change as the program is executed, enabling the processor elements to be used efficiently.

In the above-described program, the execution history obtaining part may count a number of executions of the certain execution path and holds information indicating the number of executions of the certain execution path as the execution history, and the parallel execution judgment part judges not to execute the second program part and the first program part in parallel with each other when the number of executions of the certain execution path indicated by the execution history is smaller than a predetermined threshold value.

With the above-stated structure where the parallel execution judgment part judges not to execute the second program part and the first program part in parallel with each other when the number of executions of the certain execution path is smaller than a predetermined threshold value, it is possible to prevent processor elements from being assigned to program parts with low execution frequencies where the number of executions is lower than the threshold value, thus enabling the processor elements to be used efficiently.

The above-described program may further comprise a third program part that is repeatedly executed in parallel with the first program part, and includes (i) a block that has a process content that is equivalent with a process content of a part of a second execution path that is other than a first execution path being the certain execution path, among the plurality of execution paths that does not include the branch instruction, the block of the third program part having a smaller execution time than the part of the second execution path, (ii) a block that judges whether or not a condition for executing the second execution path is satisfied, and (iii) a block that controls, when it is judged that the condition is satisfied with respect to a repetitive execution unit, to process a next repetitive execution unit together with the first program part, wherein when the parallel execution judgment part judges not to execute the second program part and the first program part in parallel with each other, the parallel execution judgment part repeatedly judges, in accordance with the obtained execution history, whether or not to execute the third program part and the first program part in parallel with each other, and the processor element assignment control part assigns a first processor element to the first program part, and performs a control to determine whether to assign a second processor element to the third program part, and execute the first program part and the third program part in parallel with each other, depending on a result of the judgment made by the parallel execution judgment part on whether or not to execute the third program part and the first program part in parallel with each other.

With the above-stated structure, when the parallel execution judgment part judges not to execute the second program part and the first program part in parallel with each other, the parallel execution judgment part judges, in accordance with the obtained execution history, whether or not to execute the third program part and the first program part in parallel with each other, the third program part including a block that has a process content of the second execution path that is other than the certain execution path among the plurality of execution paths. With the stated structure, it is possible to increase the possibility that a processor element is assigned to a program part with a higher execution frequency.

In the above-described program, the execution history obtaining part may count a number of executions of the certain execution path and holds information indicating the number of executions of the certain execution path as the execution history, and the parallel execution judgment part judges not to execute the second program part and the first program part in parallel with each other when the processor element assignment control part performed a control to determine to assign a second processor element to the second program part and execute the second program part and the first program part in parallel with each other, and when the number of executions of the certain execution path indicated by the execution history is smaller than a predetermined threshold value, and the processor element assignment control part performs a control to stop executing the second program part and the first program part in parallel with each other.

With the above-stated structure where the processor element assignment control part performs a control to stop executing the second program part and the first program part in parallel with each other when the number of executions of the certain execution path is smaller than a predetermined threshold value, it is possible to restrict the power consumption that occurs due to an execution of a program with a low execution frequency.

In the above-described program, the execution history obtaining part may count a number of executions of the certain execution path and holds information indicating the number of executions of the certain execution path as the execution history, and the parallel execution judgment part judges not to execute the second program part and the first program part in parallel with each other when the processor element assignment control part performed a control to determine to assign a second processor element to the second program part and execute the second program part and the first program part in parallel with each other, and when the number of executions of the certain execution path indicated by the execution history is smaller than a predetermined threshold value, and the processor element assignment control part performs a control to cancel assignment of the second processor element to the second program part.

With the above-stated structure where the processor element assignment control part cancels assignment of the second processor element to the second program part when the number of executions of the certain execution path is smaller than a predetermined threshold value, it is possible to assign a processor element, which has been assigned to a program with a low execution frequency, to another process, thus enabling the processor element to be used efficiently.

The above-described program may further comprise: a third program part that is repeatedly executed in parallel with the first program part, and includes (i) a block that has a process content that is equivalent with a process content of a part of a second execution path that is other than the certain execution path, among the plurality of execution paths that does not include the branch instruction, the block of the third program part having a smaller execution time than the part of the second execution path, (ii) a block that judges whether or not a condition for executing the second execution path is satisfied, and (iii) a block that controls, when it is judged that the condition is satisfied with respect to a repetitive execution unit, to process a next repetitive execution unit together with the first program part; and another execution history obtaining part that is included in the third program part and obtains and holds an execution history of the second execution path, wherein when the parallel execution judgment part judges not to execute the second program part and the first program part in parallel with each other, the parallel execution judgment part repeatedly judges, in accordance with the execution history held by the another execution history obtaining part included in the third program part, whether or not to execute the third program part and the first program part in parallel with each other, and the processor element assignment control part assigns a first processor element to the first program part, and performs a control to determine whether to assign a second processor element to the third program part, and execute the first program part and the third program part in parallel with each other, depending on a result of the judgment made by the parallel execution judgment part on whether or not to execute the third program part and the first program part in parallel with each other.

With the above-stated structure, when the assignment of the second processor element to the second program part is cancelled, the parallel execution judgment part judges, in accordance with the execution history, whether or not to execute the third program part and the first program part in parallel with each other, the third program part including a block that has a process content that is equivalent with a process content of a second execution path that is other than the certain execution path, among the plurality of execution paths. With the stated structure, it is possible to increase the possibility that a processor element is assigned to a program part with a higher execution frequency.

The above-described program may further comprise an assignment available number obtaining part to obtain information indicating a number of assignable processor elements that can be assigned among the plurality of processor elements of the computer, wherein the processor element assignment control part further includes an assignment availability judgment part to count a number of assigned processor elements that have been assigned, and judge whether or not the number of assigned processor elements is smaller than the number of assignable processor elements, and the processor element assignment control part performs a control to assign a second processor element to the second program part, and execute the first program part and the second program part in parallel with each other when the number of assigned processor elements is smaller than the number of assignable processor elements when the parallel execution judgment part judges to execute the second program part and the first program part in parallel with each other.

With the above-stated structure where the processor element assignment control part assigns a second processor element to the second program part when the number of assigned processor elements is smaller than the number of assignable processor elements. With the stated structure, it is possible to perform the parallel execution depending on the number of assignable processor elements.

The above-described program may further comprise an execution history initializing part to initialize the execution history each time the parallel execution judgment part performs the judgment.

With the above-stated structure, the execution history initializing part initializes the execution history each time the parallel execution judgment part judges whether or not to execute the first and second program parts in parallel with each other, and the parallel execution judgment part performs a judgment based on the execution history that was obtained after the preceding judgment. With the stated structure, it is possible to assign a processor element by taking into account the execution history that may change as the program is executed, thus enabling the processor element to be used efficiently.

The above-described program may further comprise a third program part that is repeatedly executed in parallel with the first program part, and includes (i) a first block that has a process content that is equivalent with a process content of a first no-branch part that is part of a first execution path being the certain execution path and does not include the branch instruction, among the plurality of execution paths, the first block of the third program part having a smaller execution time than the first no-branch part, (ii) a block that judges whether or not a condition for executing the first execution path is satisfied, (iii) a second block that has a process content that is equivalent with a process content of a second no-branch part that is part of a second execution path being another certain execution path other than the first execution path and does not include the branch instruction, among the plurality of execution paths, the second block of the third program part having a smaller execution time than the second no-branch part, (iv) a block that controls, when it is judged that the condition for executing the first execution path is satisfied with respect to a repetitive execution unit, to process a next repetitive execution unit together with the first program part, and controls, when it is judged that the condition is not satisfied, to judge whether or not a condition for executing the second execution path is satisfied, and (v) a block that controls, when it is judged that the condition for executing the second execution path is satisfied with respect to a repetitive execution unit, to process a next repetitive execution unit together with the first program part, wherein the parallel execution judgment part repeatedly judges, in accordance with the obtained execution history, whether or not to execute the third program part and the first program part in parallel with each other, and the processor element assignment control part assigns a first processor element to the first program part, and performs a control to determine whether to assign a second processor element to the third program part, and execute the first program part and the third program part in parallel with each other, depending on a result of the judgment made by the parallel execution judgment part on whether or not to execute the third program part and the first program part in parallel with each other.

With the above-stated structure, when the processor element assignment control part performs a control to assign a second processor element to the third program part, and execute the first program part and the third program part in parallel with each other, and when it is judged that the condition for executing the first execution path is not satisfied, the same processor element performs the process for the second execution path in continuation to the process for the first execution path. With the stated structure, it is possible to use a processor element efficiently.

In the above-described program, when the parallel execution judgment part judges not to execute the second program part and the first program part in parallel with each other, the second execution path included in the third program part may be set to be a certain execution path in the second program part.

With the above-stated structure, when the parallel execution judgment part judges not to execute the second program part and the first program part in parallel with each other, and then if the condition for executing the first execution path is not satisfied, the same processor element performs the process for a certain execution path in the second program part in continuation to the process for the first execution path. With the stated structure, it is possible to use a processor element efficiently.

In the above-described program, the execution history obtaining part may be included in the third program part, count a number of executions of the first execution path, count a number of executions of the second execution path, and hold the numbers of executions of the first and second execution paths as the execution history, and the number of executions of the first execution path is greater than the number of executions of the second execution path.

With the above-stated structure, when an attempt is made to execute the first execution path having a greater number of executions, but the condition for executing the first execution path is not satisfied, the second execution path, whose number of executions is lower than that of the first execution path, is executed. With the stated structure, it is possible to use a processor element efficiently, and increase the possibility that a high-speed processing is achieved.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings:

FIG. 1 shows the structure of the program generating device 100 for generating the program of the present invention;

FIG. 2 is a control flow graph showing a control flow in a part of the source program 110;

FIG. 3 shows the structure of the execution program 130 of Embodiment 1;

FIG. 4 shows the structure of the compensation path code 132 and the specific path codes;

FIG. 5 is a flowchart showing the procedures in which the parallel execution control unit 131 selects paths;

FIG. 6 is a flowchart showing the procedures in which the parallel execution control unit 131 assigns processor elements;

FIG. 7 is a flowchart showing the procedures in which the history update code 407 updates the execution history information 301 and the total execution number information 302;

FIG. 8 is a flowchart showing the procedures in which the history update code 420 updates the execution history information 301 and the total execution number information 302;

FIG. 9 is a flowchart showing the procedures in which the parallel execution control unit 131 reviews the specific path codes that are to be executed in parallel;

FIG. 10 shows the structure of the execution program 1000 of Embodiment 2;

FIG. 11 shows the structure of the compensation path code 132 and the specific path codes;

FIG. 12 is a flowchart showing the procedures in which the parallel execution control unit 1001 reviews the specific path codes that are to be executed in parallel; and

FIG. 13 shows relationships between the program structure of the present invention and the program execution device.

### DESCRIPTION OF THE PREFERRED EMBODIMENT

The following describes a program of the present invention through preferred embodiments thereof, with reference to the attached drawings.

### Embodiment 1

### <Overview>

The program of Embodiment 1 is a program to be executed by a processor having a plurality of processor elements, namely, a program to be executed by a computer (hereinafter referred to as “target hardware”). The program of Embodiment 1 has been improved from a conventional program.

The program of Embodiment 1 includes: a code sequence (hereinafter referred to as “compensation path code”) that includes a code sequence that is generated by converting a source program, which includes a part to be executed repeatedly, into an execution format; and code sequences (hereinafter referred to as “specific path codes”) that include code sequences that respectively correspond to a plurality of paths (not having branch instructions therein) contained in the compensation path code.

Each of the compensation path code and the specific path codes includes a history update process code that increments, “1” by “1”, the execution history information and the total execution number information, where the execution history information indicates the number of executions of a path, and the total execution number information indicates a total execution number that is a total number of executions of the compensation path code and each specific path code. When the program of Embodiment 1 is executed, the total execution number information and the execution history information for the paths that have satisfied conditions for executing the paths are updated.

The program of Embodiment 1 performs a control to: select, based on the execution history information, specific path codes that are executed with high frequency, so as to be executed in parallel with the compensation path code; assigns processor elements to the compensation path code and the selected specific path codes depending on the number of processor elements that can be used on the target hardware; and execute, in parallel with each other, the compensation path code and the specific path codes to which the processor elements have been assigned.

The above-described control can be achieved via an OS (Operating System) or the like so that processor elements of the processor are assigned to the compensation path code and the selected specific path codes.

Further, the program of Embodiment 1: conducts a review of the specific path codes that are to be executed in parallel with the compensation path code, each time the total number of actual executions reaches a predetermined number indicated by the total execution number information; detects, in the review, specific path codes, among those executed in parallel, whose execution frequency decreased during a period from the preceding review to the present review, based on the execution history information; and removes the detected specific path codes from those executed in parallel, namely, stops the operation of processor elements assigned to the detected specific path codes and cancels the assignment of the processor elements thereto.

Further, when there are specific path codes, among those that are not currently executed in parallel, that are executed with high frequency, the program of Embodiment 1 assigns processor elements to the specific path codes having high execution frequency, depending on the number of processor elements that are usable on the target hardware, and performs a control to execute the specific path codes to which the processor elements were assigned, in parallel with the compensation path code.

As described above, the program of Embodiment 1 causes the compensation path code to be executed in parallel with the specific path codes having high execution frequency, based on the execution history information that the program of Embodiment 1 updates as it is executed. Such a structure of the program of Embodiment 1 enables the processor elements of the target hardware to be used efficiently, and increases the possibility that the execution time of the program of Embodiment 1 is reduced.

### <Program Generating Device 100>

A program generating device 100 for generating the program of Embodiment 1 will be described.

<Structure of Program Generating Device>

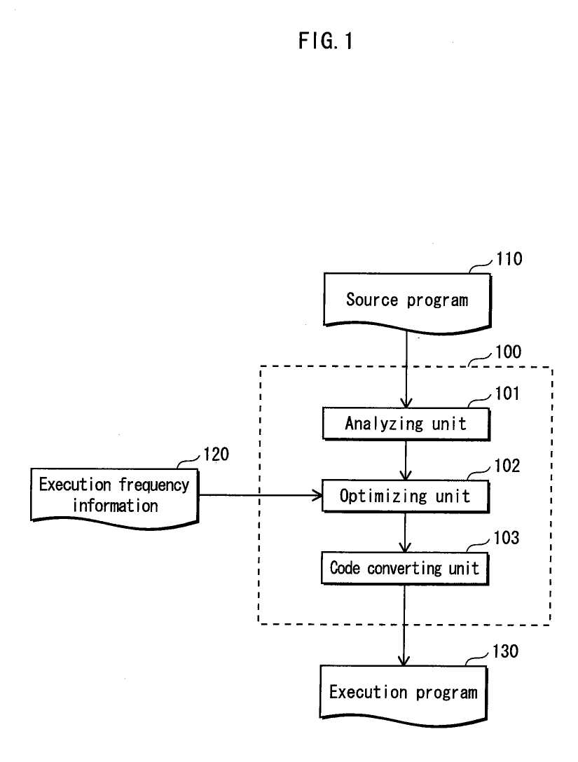

The structure of the program generating device 100 for generating the program of Embodiment 1 will be described with reference to FIG. 1.

As shown in FIG. 1, the program generating device 100 includes an analyzing unit 101, an optimizing unit 102, and a code converting unit 103.

Although not illustrated, the program generating device 100 also includes a processor and a memory, and each function of the analyzing unit 101, optimizing unit 102, and code converting unit 103 is achieved by causing the processor to execute a compiler that is a code conversion program stored in the memory.

The analyzing unit 101 has a function to analyze branches and executions of a source program 110 and output, to the optimizing unit 102, path information that is obtained by the analysis and relates to paths contained in the source program 110.

The optimizing unit 102 has a function to generate intermediate codes by optimizing the paths contained in the source program 110, namely, by changing the execution order of instructions (except for branch instructions) contained in the paths that are executed with high frequency, based on (i) the path information received from the analyzing unit 101, and (ii) execution frequency information 120 that is information regarding the execution frequency of each path, such that the execution time of the instructions is reduced. The optimizing unit 102 outputs the generated intermediate code to the code converting unit 103.

It should be noted here that the execution frequency information 120 can be obtained preliminarily by performing profiling. The profiling is a process of obtaining the execution frequency of each path by detecting which path was selected at a branching point when a branch instruction in the source program 110 is executed, incorporating, into the source program 110, a profiling code that counts one each time any path in the source program 110 passes the selected path, and executing an execution program that is generated by converting the source program 110 into an execution format.

Also, it is judged for each path whether or not the path has a high execution frequency by comparing the execution frequency information 120 with a code generation threshold value that is preliminarily given from the software developer.

The code converting unit 103 has a function to generate an execution program 130 that is executable on the target hardware, and output the generated execution program 130.

The execution program 130 includes a compensation path code, specific path codes, and a parallel execution control code. The compensation path code includes a process content code that is generated by converting the source program 110 into an execution format. Each of the specific path codes includes a process content code that is generated by converting an intermediate code of each path with a high execution frequency received from the optimizing unit 102, into an execution format. The parallel execution control code selects specific path codes that are to be executed in parallel, based on the execution history information that indicates the number of executions of the paths corresponding to the specific path codes, and performs a control so that processor elements are assigned to the compensation path code and to the selected specific path codes, and also performs a control to cancel the assignment of the processor elements to the specific path codes.

Each of the compensation path code and the specific path codes includes a history update process code that increments, “1” by “1”, the execution history information and the total execution number information, where the execution history information indicates the number of executions of a path, and the total execution number information indicates a total execution number that is a total number of executions of the compensation path code and each specific path code. When the program of Embodiment 1 is executed, the total execution number information and the execution history information for the paths that have satisfied the execution conditions are updated.

With the stated structure where controls on the assignment and assignment cancellation of processor elements to each specific path code are performed based on the execution history information that is updated when the execution program 130 is executed, it is possible to use the processor elements efficiently.

Also, whenever the execution program 130 is executed, the compensation path code is executed. Accordingly, when an actually executed path is not a specific path code, it is possible to maintain the compatibility among the execution results; and when an actually executed path is a specific path code, it is executed at a higher speed than the compensation path code since each specific path code has been optimized to have a reduced execution time.

Details of the execution program 130 will be described later.

<Data>

In the following, the data to be input into the program generating device 100 is described.

<Source Program 110>

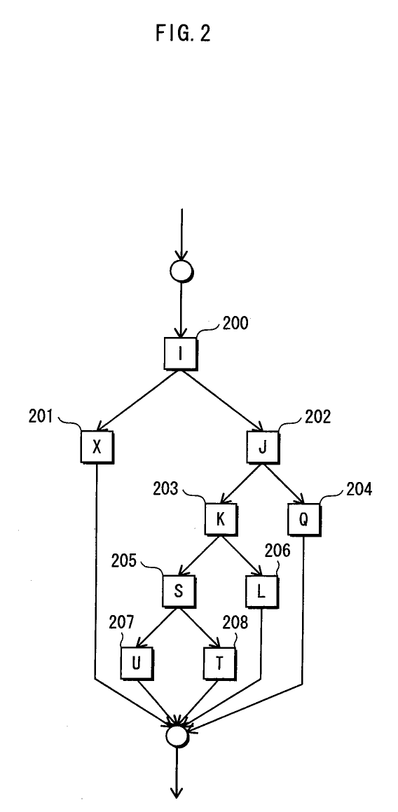

FIG. 2 is a control flow graph showing a control flow in a part of the source program 110 (hereinafter referred to as a partial program). The partial program of this example includes a branch instruction and is repeatedly executed in the entire source program 110. The partial program includes a block 1200, a block X 201, a block J 202, a block K 203, a block Q 204, a block S 205, a block L 206, a block U 207, and a block T 208, which are basic blocks. The basic block is a continuous sequence of instructions that does not include a branch instruction.

The paths shown in the control flow graph of FIG. 2 include the following five paths: (1) a path that passes blocks I 200→J 202→Q 204 (hereinafter the path is referred to as “path IJQ”); (2) a path that passes blocks I 200→J 202→K 203→L 206 (hereinafter the path is referred to as “path IJKL”); (3) a path that passes blocks I 200→J 202→K 203→S 205→T 208 (hereinafter the path is referred to as “path IJKST”); (4) a path that passes blocks I 200→J 202→K 203→S 205→U 207 (hereinafter the path is referred to as “path IJKSU”); and (5) a path that passes blocks I 200→X 201 (hereinafter the path is referred to as “path IX”).

<Execution Frequency Information 120>

Each piece of the execution frequency information 120 includes: an identifier for identifying a path contained in the source program; and the number of times the path identified by the identifier is executed when a profiling is executed on the target hardware or another computer.

In the following description, it is presumed as one example that a profiling was performed, a part of the source program 110 shown in FIG. 2 was executed a hundred times in the profiling, and the numbers of executions of the paths obtained as a result of the profiling were: 60 with path IJQ; 30 with path IJKL; 5 with path IJKST; 3 with path IX; and 2 with path IJKSU.

<Operation of Program Generating Device 100>

The following will describe, as an example, an operation of the program generating device 100 after it receives the partial program of the source program 110 shown in FIG. 2 until it outputs the execution program 130.

In the following description, it is presumed that the code generation threshold value that has been specified by the software developer is “5%”.

The analyzing unit 101, upon receiving the source program 110, analyzes the source program 110 to obtain the path information (from the analysis of the partial program shown in FIG. 2, the path information of the five paths IJQ, IJKL, IJKST, IX, and IJKSU is obtained), and outputs the obtained path information to the optimizing unit 102.

The optimizing unit 102 generates intermediate codes by optimizing the paths to have optimized execution times, namely, by changing the execution order of instructions (except for branch instructions) contained in the paths that are executed with high frequency that is equal to or higher than the code generation threshold value (5%) (in the partial program shown in FIG. 2, three paths IJQ, IJKL, and IJKST), based on (i) the path information received from the analyzing unit 101, and (ii) the execution frequency information 120 that has been obtained preliminarily by the profiling. The optimizing unit 102 outputs the generated intermediate codes to the code converting unit 103.

The code converting unit 103 generates the execution program 130 and outputs the generated execution program 130. The execution program 130 includes a compensation path code, specific path codes, and a parallel execution control code. The compensation path code includes a process content code that is generated by converting the source program 110 into an execution format. Each of the specific path codes includes a process content code that is generated by converting an intermediate code of each path with a high execution frequency (in the partial program shown in FIG. 2, three paths IJQ, IJKL, and IJKST) received from the optimizing unit 102, into an execution format. The parallel execution control code selects specific path codes that are to be executed in parallel, based on the execution history information that indicates the number of executions of the paths corresponding to the specific path codes, and performs a control so that processor elements are assigned to the compensation path code and to the selected specific path codes, and also performs a control to cancel the assignment of the processor elements to the specific path codes.

Each of the compensation path code and the specific path codes includes a history update process code that increments, “1” by “1”, the execution history information and the total execution number information, where the execution history information indicates the number of executions of a path, and the total execution number information indicates a total execution number that is a total number of executions of the compensation path code and each specific path code.

<Execution Program 130>

The following is an explanation of the execution program 130 of Embodiment 1.

<Structure>

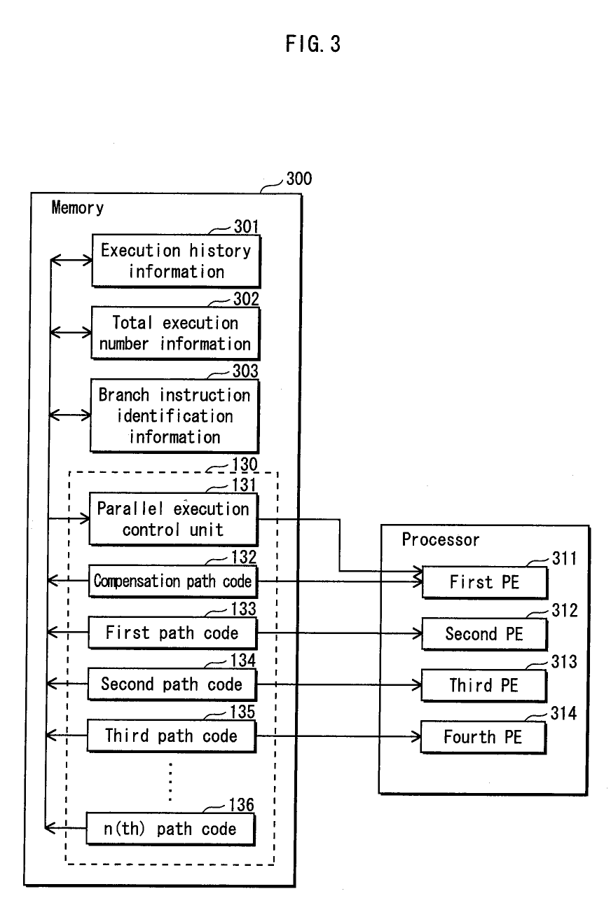

The structure of the execution program 130 of Embodiment 1 will be described with reference to FIG. 3.

As shown in FIG. 3, the execution program 130 is stored in a memory 300 provided in the target hardware, and includes a parallel execution control unit 131, a compensation path code 132, a first path code 133, a second path code 134, a third path code 135, . . . , and n^{th} path code 136.

The parallel execution control unit 131 has a function to perform a control to select, based on the number of executions of each path indicated by execution history information 301 stored in the memory 300, specific path codes that are to be executed in parallel with the compensation path code 132, from among the first path code 133, second path code 134, third path code 135, . . . , and n^{th} path code 136, and assign the processor elements to the compensation path code 132 and some or all of the selected specific path codes. It should be noted here that the number of assignable processor elements is predetermined, and thus the number of specific path codes to which processor elements are assigned is determined accordingly.

More specifically, the parallel execution control unit 131 divides the number of executions of each path indicated by the execution history information 301 stored in the memory 300 by a total number of executions indicated by total execution number information 302 stored in the memory 300, the total number of executions being a total of the numbers of executions of the compensation path code and the specific path codes, to obtain a ratio of the number of executions of each path to the total number of executions, and selects one or more specific path codes that have values of the aforesaid ratio that are higher than a path selection threshold value that will be described later.

Further, the parallel execution control unit 131 sets the number of processor elements that are usable on the target hardware, to “n”, performs a control to assign a processor element to the compensation path code 132, and also performs a control to assign a processor element to each of (n−1) pieces of specific path codes among the selected one or more specific path codes that have high ratio values, in sequence in the order from the highest ratio value to lower ratio values.

Here, the path selection threshold value may be a ratio of the number of executions of each path to a total number of executions, which is obtained by summing up the number of executions of each path obtained preliminarily by performing a profiling, or may be a ratio of the number of executions of each path to a total number of executions that is set by the software developer in an arbitrary manner. And, in the following description, it is presumed that the path selection threshold value is the latter, namely, the ratio of the number of executions of each path to a total number of executions that is set by the software developer in an arbitrary manner.

The parallel execution control unit 131 conducts a review of the specific path codes that are to be executed in parallel with the compensation path code 132, each time the total number of actual executions reaches the number (for example, “100”) indicated by the total execution number information 302 stored in the memory 300.

More specifically, the parallel execution control unit 131 selects a predetermined number of specific path codes that are to be executed in parallel with the compensation path code 132 as described above. Then, when part or all of the specific path codes that are currently executed in parallel with the compensation path code 132 are not included in the newly selected specific path codes, the parallel execution control unit 131 cancels the assignment of processor elements to the part or all of the specific path codes. Also, when part or all of the newly selected specific path codes are not included in the specific path codes that are currently executed in parallel with the compensation path code 132, the parallel execution control unit 131 assigns processor elements to the part or all of the newly selected specific path codes, depending on the number of processor elements that are usable on the target hardware.

Each time it conducts the aforesaid review of the specific path codes that are to be executed in parallel with the compensation path code 132, the parallel execution control unit 131 initializes the execution history information 301 and the total execution number information 302 stored in the memory 300, namely, sets the numbers of executions of the paths that correspond to the specific path codes to “0” and sets the total number of executions to “0” (hereinafter, the setting of the numbers to “0” is referred to as resetting). With this structure, it is possible to perform the control to assign processor elements, or to cancel the assignment of processor elements, based on the number of executions of the paths corresponding to the specific path codes having been updated during a period from the preceding review to the present review.

The parallel execution control unit 131 achieves the control to assign processor elements or cancel the assignment of processor elements, via the OS (Operating System) that operates on the target hardware. The assignment of processor elements and cancellation of the assignment are general functions of the OS, and thus the explanation thereof is omitted.

Also, the parallel execution control unit 131 itself can achieve its function when it is assigned with a processor element provided in the target hardware. FIG. 3 shows an example where the parallel execution control unit 131 is assigned with a first PE 311, as well as the compensation path code 132.

The compensation path code 132 is executed by any of the first PE 311, a second PE 312, a third PE 313, and a fourth PE 314, which are processor elements on the target hardware, when the parallel execution control unit 131 performs a control to assign the processor elements. In the example shown in FIG. 3, the first PE 311 is assigned to the compensation path code 132.

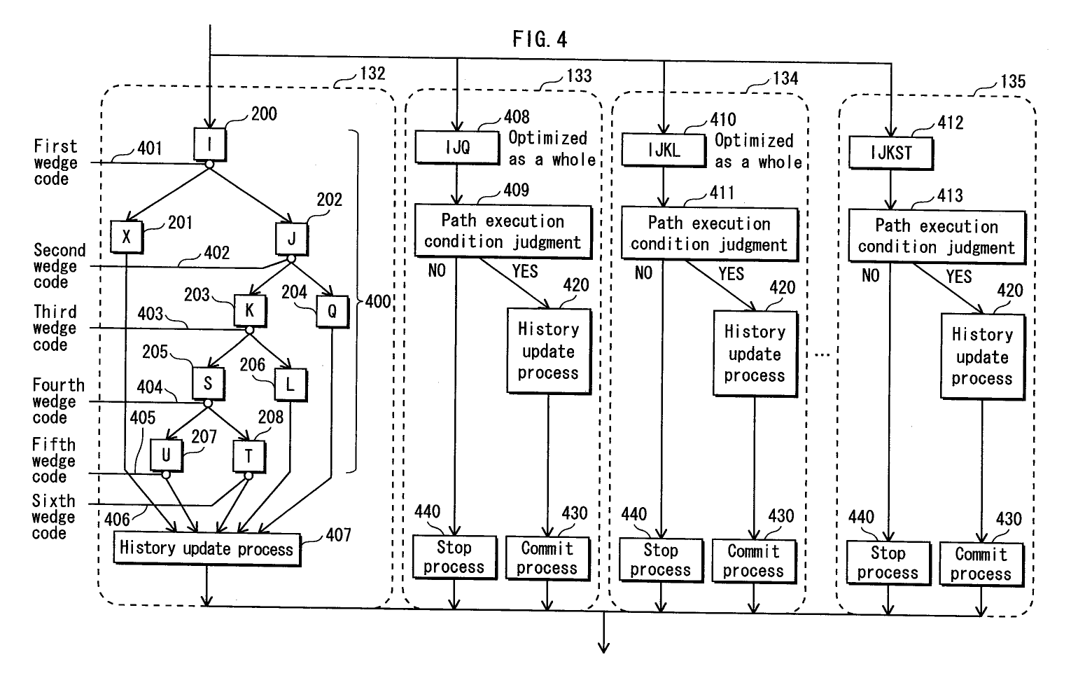

In the following, the compensation path code 132 will be described briefly with reference to FIG. 4.

FIG. 4 shows how the compensation path code 132, the first path code 133, the second path code 134, and the third path code 135, which constitute the partial program of the source program 110 shown in FIG. 2, are assigned with processor elements and are executed in parallel with each other.

As shown in FIG. 4, the compensation path code 132 includes a process content code 400, a first wedge code 401, a second wedge code 402, a third wedge code 403, a fourth wedge code 404, a fifth wedge code 405, a sixth wedge code 406, and a history update code 407.

The process content code 400 is a code sequence generated by converting a source program into an execution format, and is used to compensate the compatibility among the execution results when paths corresponding to specific path codes to be executed in parallel with each other are not executed.

The first to sixth wedge codes 401-406 respectively output different pieces of branch instruction identification information 303. The branch instruction identification information 303, having been output in this way, is used to identify a path that was actually executed. The data structure of the branch instruction identification information 303 will be described later, as well as how the branch instruction identification information 303 is used to identify an actually executed path.

The history update code 407 has a function to perform a history update process in which it identifies an actually executed path according to a combination of pieces of branch instruction identification information 303 output from the wedge codes, increments the number of executions indicated by the execution history information 301 by “1” with respect to the identified path, and increments the total number of executions indicated by the total execution number information 302 by “1”.

The first path code 133, second path code 134, third path code 135, . . . , and n^{th} path code 136 are specific path codes that are executed in parallel with the compensation path code 132. When the parallel execution control unit 131 performs a control to assign processor elements based on the numbers of executions of paths corresponding to the specific path codes indicated by the execution history information 301, the first path code 133, second path code 134, third path code 135, and n^{th} path code 136 are executed by any of the first PE 311, the second PE 312, the third PE 313, and the fourth PE 314, which are processor elements on the target hardware. In the example shown in FIG. 3, the second PE 312, the third PE 313, and the fourth PE 314 are assigned to the first path code 133, the second path code 134, and the third path code 135, respectively, and no processor element is assigned to the n^{th} path code 136.

Since, basically, the first path code 133, second path code 134, third path code 135, . . . , and n^{th} path code 136 have the same structure, in the following detailed description, the first path code 133 will be used, with reference to FIG. 4.

As shown in FIG. 4, the first path code 133 includes a process content code 408, a path condition judgment code 409, a history update code 420, a commit code 430, and a stop code 440.

The process content code 408 is generated by converting, into an execution format, an intermediate code that is generated by changing the execution order of instructions (except for branch instructions) contained in the path IJQ such that the execution time of the instructions is reduced. The process content codes are different from each other in correspondence with the specific path codes. A process content code 410 is generated by converting, into an execution format, an intermediate code that was optimized with respect to the path IJKL; and a process content code 412 is generated by converting, into an execution format, an intermediate code that was optimized with respect to the path JKDST.

The path condition judgment code 409 has a function to judge whether or not a condition for executing the path IJQ is satisfied. The path condition judgment codes are different from each other in correspondence with the specific path codes. A path condition judgment code 411 judges whether or not a condition for executing the path IJKL is satisfied; and a path condition judgment code 413 judges whether or not a condition for executing the path JKDST is satisfied.

The history update code 420 is executed when a path condition judgment code judges that satisfied is a condition for executing a path corresponding to an own specific path code to which the history update code 420 belongs, and has a function to increment, by “1”, the number of executions of the path indicated by the execution history information 301, and incrementing the total number of executions indicated by the total execution number information 302 by “1”. For example, the history update code 420 in the first path code 133 increments the number of executions of the path IJQ by “1”.

The commit code 430 is executed after the history update code 420 is executed, and has a function to stop the execution of path codes other than the own path code to which it belongs, namely stop the execution of the compensation path code 132 and the other specific path codes, so as to cause the calculation result obtained by executing the own specific path code to be reflected.

The stop code 440 is executed when the path condition judgment code 409 judges that a condition is not satisfied, and has a function to stop the execution of the own path code to which it belongs.

It should be noted here that the process content code 408 is generated by converting, into an execution format, an intermediate code that has been optimized to have a reduced execution time, and that the execution time of a specific path code is shorter than that of the compensation path code 132.

Accordingly, when the path condition judgment code 409 judges that a condition for executing a path corresponding to a specific path code is satisfied, the commit code 430 is executed to stop the execution of the compensation path code 132, and thus the history update code 407 contained in the compensation path code 132 is not executed.

<Data>

Here will be described the data used by the execution program 130 stored in the memory 300 of the target hardware.

The execution history information 301 includes identifiers for identifying the paths contained in the source program, and includes the numbers of executions indicating the numbers of actual executions of the paths identified by the identifiers, on the target hardware.

When the history update code 407 of the compensation path code 132 or the history update code 420 of a specific path code is executed, the number of executions indicating the number of actual executions of the corresponding path is incremented by “1”.

The total execution number information 302 indicates the total number of executions of the compensation path code 132 and each specific path code. When the history update code 407 of the compensation path code 132 or the history update code 420 of a specific path code is executed, the total number of executions is incremented by “1”.

The branch instruction identification information 303 is output when each of the first to sixth wedge codes 401-406 shown in FIG. 4 is executed. Each piece of branch instruction identification information 303 identifies the wedge code from which it was output. By using the branch instruction identification information 303, it is possible to identify an actually executed path.

The branch instruction identification information 303 may take any form in so far as it can identify one of the first to sixth wedge codes 401-406 that was executed. In the following, it is presumed, as one example, that “1” to “6” are output as the branch instruction identification information 303 when the first to sixth wedge codes 401-406 are executed, respectively.

For example, when only “1” is output as the branch instruction identification information 303, it is recognized that the basic block 1200 was executed. It also indicates that the basic block J 202 was not executed, and that the basic block X 201 was executed. In this way, it is possible to identify the path IX as the actually executed path.

<Operation>

Here, the operation of the execution program 130 will be described.

<Path Selection>

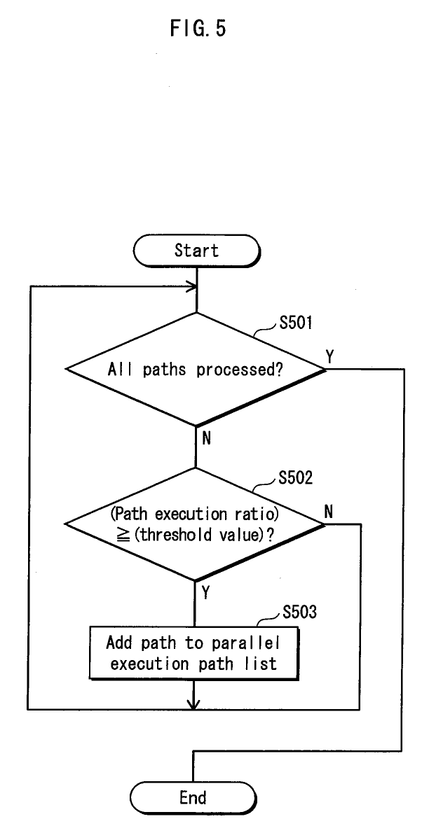

In the following, the path selection process performed by the parallel execution control unit 131 will be described with reference to the flowchart shown in FIG. 5.

The parallel execution control unit 131 judges whether or not all the paths corresponding to the specific path codes were processed in step S502 (step S501).

When it judges that all the paths corresponding to the specific path codes were not processed (“N” in step S501), the parallel execution control unit 131 judges, based on the execution history information 301 and the total execution number information 302 stored in the memory 300, whether or not a ratio of the number of executions of a path, which has not been processed, to the total number of executions is equal to or greater than the path selection threshold value that was set by the software developer in an arbitrary manner (step S502).

When it judges that the ratio of the number of executions of the path to the total number of executions is equal to or greater than the path selection threshold value (“Y” in step S502), the parallel execution control unit 131 adds the path to a parallel execution path list such that each value of the ratio of the number of executions of a path to the total number of executions is arranged in the descending order (step S503), and returns to step S501.

When it judges that the ratio of the number of executions of the path to the total number of executions is smaller than the path selection threshold value (“N” in step S502), the parallel execution control unit 131 returns to step S501.

When the parallel execution control unit 131 judges that all the paths corresponding to the specific path codes were processed (“Y” in step S501), the process ends.

<Assignment of Processor Elements>

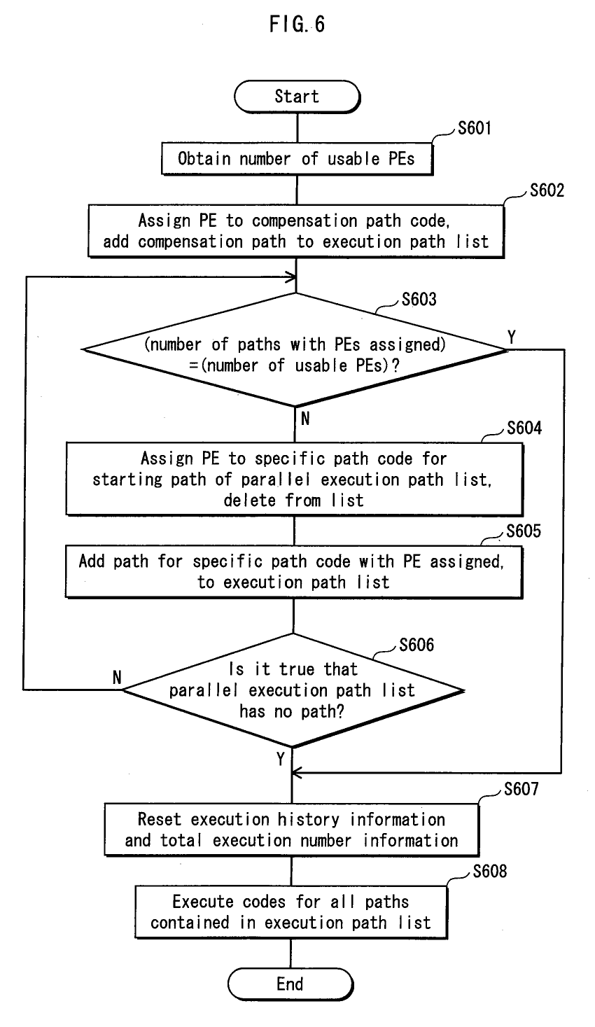

In the following, the processor element assignment process performed by the parallel execution control unit 131 will be described with reference to the flowchart shown in FIG. 6.

The parallel execution control unit 131 obtains information indicating the number of processor elements that can be used on the target computer (step S601).

The parallel execution control unit 131 assigns a processor element to the compensation path code 132, and adds a compensation path to an execution path list (step S602).

The parallel execution control unit 131 judges whether or not the number of paths to which processor elements have been assigned is equal to the number of processor elements that can be used on the target computer (step S603).

When it judges that the number of paths to which processor elements have been assigned is not equal to the number of processor elements that can be used on the target computer (“N” in step S603), the parallel execution control unit 131 assigns a processor element to a specific path code corresponding to the starting path of the parallel execution path list, namely a path that has the highest value of the ratio of the number of executions of the path to the total number of executions, among the paths included in the parallel execution path list, and deletes, from the parallel execution path list, the path corresponding to the specific path code to which the processor element was assigned (step S604).

The parallel execution control unit 131 adds, to the execution path list, the path that corresponds to the specific path code to which the processor element was assigned (step S605).

The parallel execution control unit 131 judges whether or not it is true that the parallel execution path list does not contain a path (step S606).

When it judges that it is not true that the parallel execution path list does not contain a path (“N” in step S606), the parallel execution control unit 131 returns to step S603; and when it judges that it is true (“Y” in step S606), the parallel execution control unit 131 resets the number of executions of each path indicated by the execution history information 301 and the total number of executions indicated by the total execution number information 302 (step S607).

The parallel execution control unit 131 executes the codes (the compensation path code 132 and specific path codes corresponding to the paths contained in the execution path list) that correspond to all the paths contained in the execution path list (step S608).

When it judges that the number of paths to which processor elements have been assigned is equal to the number of processor elements that can be used on the target computer (“Y” in step S603), the parallel execution control unit 131 goes to step S607.

<Operation of History Update Code 407>

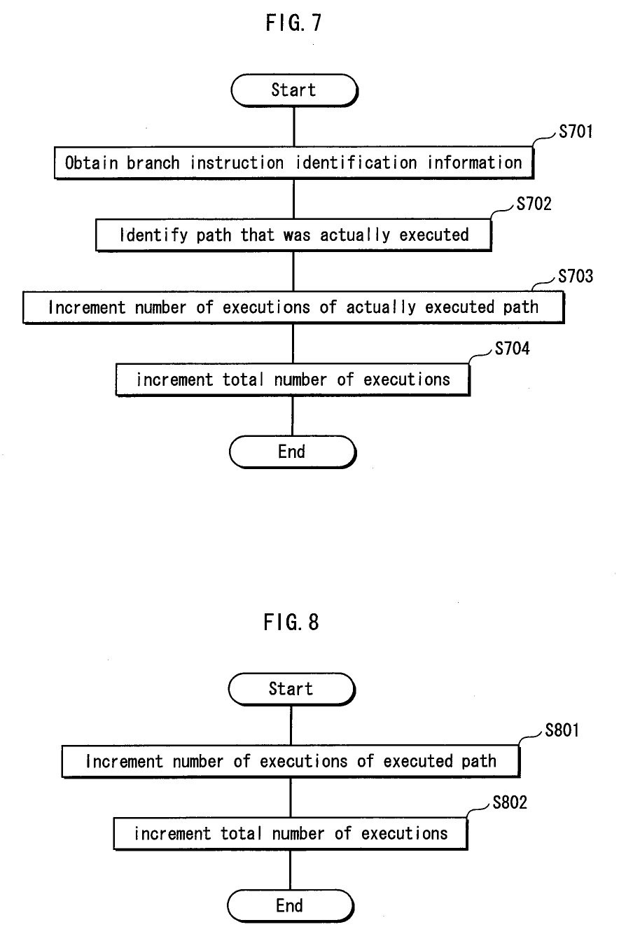

The following will describe the history update process in which the history update code 407 contained in the compensation path code 132 updates the execution history information 301 and the total execution number information 302, with reference to the flowchart shown in FIG. 7.

The history update code 407 obtains the branch instruction identification information 303 stored in the memory 300 (step S701).

The history update code 407 identifies a path that was actually executed, by referring to the obtained branch instruction identification information 303 (step S702).

The history update code 407 increments, by “1”, the number of executions of the actually executed path that is identified by one of the identifiers included in the execution history information 301 stored in the memory 300 (step S703).

The history update code 407 increments the total number of executions indicated by the total execution number information 302 by “1” (step S704).

<Operation of History Update Code 420>

The following will describe the history update process in which the history update code 420 contained in each specific path code updates the execution history information 301 and the total execution number information 302, with reference to the flowchart shown in FIG. 8.

The history update code 420 increments, by “1”, the number of executions of a path corresponding to an own specific path code, the path being identified by one of the identifiers included in the execution history information 301 (step S801).

The history update code 420 increments the total number of executions indicated by the total execution number information 302 by “1” (step S802).

<Review of Assignment of Processor Elements>

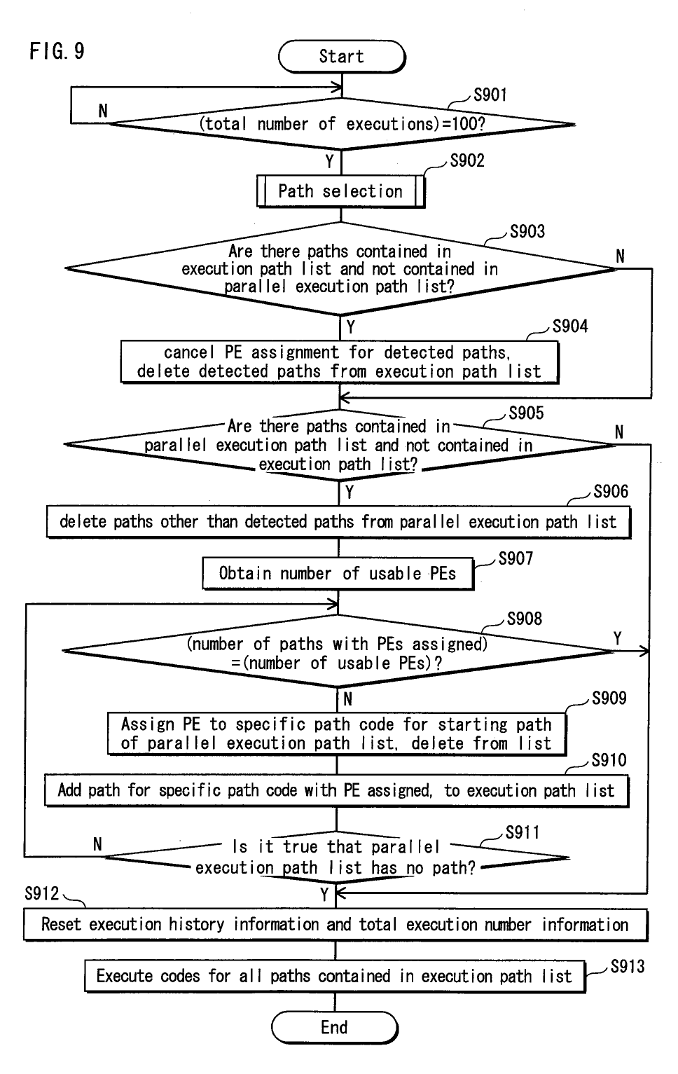

The following will describe the process of reviewing the specific path codes that are to be executed in parallel with the compensation path code 132, with reference to the flowchart shown in FIG. 9.

The parallel execution control unit 131 judges whether or not the total number of executions indicated by the total execution number information 302 stored in the memory 300 is equal to “100” (step S901).

When it judges that the total number of executions is not equal to “100” (“N” in step S901), the parallel execution control unit 131 returns to step S901.

When it judges that the total number of executions is equal to “100” (“Y” in step S901), the parallel execution control unit 131 performs the path selection process in accordance with the flowchart shown in FIG. 5 to select paths corresponding to specific path codes that are to be executed in parallel with the compensation path code 132 (step S902).

The parallel execution control unit 131 judges whether or not there are paths that are contained in the execution path list and are not contained in the parallel execution path list (step S903).

When it judges that there are paths that are contained in the execution path list and are not contained in the parallel execution path list (“Y” in step S903), the parallel execution control unit 131 cancels the assignment of processor elements to the specific path codes corresponding to all the detected paths, and deletes all the detected paths from the execution path list (step S904), and goes to step S905.

When it judges that there are no such paths that are contained in the execution path list and are not contained in the parallel execution path list (“N” in step S903), the parallel execution control unit 131 goes to step S905.

The parallel execution control unit 131 judges whether or not there are paths that are contained in the parallel execution path list and are not contained in the execution path list (step S905).

When it judges that there are paths that are contained in the parallel execution path list and are not contained in the execution path list (“Y” in step S905), the parallel execution control unit 131 deletes paths other than the detected paths, from the parallel execution path list (step S906), and goes to step S907.

When it judges that there are no such paths that are contained in the parallel execution path list and are not contained in the execution path list (“N” in step S905), the parallel execution control unit 131 goes to step S912.

Description of the steps following this is omitted since: step S907 is the same as steps S601 in the processor element assignment process shown in FIG. 6; and steps S908-S913 are the same as steps S603-S608 in the processor element assignment process shown in FIG. 6.

<Operation with Specific Example>

The operation of the execution program 130 will be described in more detail using, as an example, the part of the source program 110 shown in FIG. 2.

<Path Selection>

In the following, the path selection process performed by the parallel execution control unit 131 will be described with reference to the flowchart shown in FIG. 5.

In the following description, it is presumed that the memory 300 stores specific path codes corresponding to paths IJQ, IJKL, IJKST, and IX, respectively as the first, second, third, and fourth path codes.

In the following description, it is also presumed that a profiling, in which a part of the source program 110 shown in FIG. 2 was executed a hundred times, was performed, and the results of the profiling are used as the initial values of the execution history information 301, and that the numbers of executions of the paths obtained by the profiling were: 60 with path IJQ; 30 with path IJKL; 5 with path IJKST; 3 with path IX; and 2 with path IJKSU.

In the following description, it is also presumed that the path selection threshold value that has been specified by the software developer in an arbitrary manner is “5%”.

The parallel execution control unit 131 judges whether or not all of paths IJQ, IJKL, IJKST, and IX were processed in step S502 (step S501).

The parallel execution control unit 131 judges in the negative since paths IJQ, IJKL, IJKST, and IX were not processed in step S502 (“N” in step S501). The parallel execution control unit 131 judges, based on the execution history information 301 and the total execution number information 302 stored in the memory 300, whether or not the ratio (60%) of the number of executions of path IJQ, which has not been processed, to the total number of executions is equal to or greater than the path selection threshold value (5%) that was set by the software developer in an arbitrary manner (step S502).

The parallel execution control unit 131 judges that the ratio (60%) of the number of executions of path IJQ is equal to or greater than the path selection threshold value (5%) (“Y” in step S502). The parallel execution control unit 131 adds the path IJQ to the parallel execution path list (step S503), and returns to step S501.

The parallel execution control unit 131 judges whether or not all of paths IJQ, IJKL, IJKST, and IX were processed in step S502 (step S501).

The parallel execution control unit 131 judges in the negative since paths IJKL, IJKST, and IX were not processed in step S502 (“N” in step S501). The parallel execution control unit 131 judges, based on the execution history information 301 and the total execution number information 302 stored in the memory 300, whether or not the ratio (30%) of the number of executions of path IJKL, which has not been processed, to the total number of executions is equal to or greater than the path selection threshold value (5%) that was set by the software developer in an arbitrary manner (step S502).

The parallel execution control unit 131 judges that the ratio (30%) of the number of executions of path IJKL is equal to or greater than the path selection threshold value (5%) (“Y” in step S502). The parallel execution control unit 131 adds the path IJKL to the parallel execution path list (step S503), and returns to step S501.

The parallel execution control unit 131 judges whether or not all of paths IJQ, IJKL, IJKST, and IX were processed in step S502 (step S501).

The parallel execution control unit 131 judges in the negative since paths IJKST and IX were not processed in step S502 (“N” in step S501). The parallel execution control unit 131 judges, based on the execution history information 301 and the total execution number information 302 stored in the memory 300, whether or not the ratio (5%) of the number of executions of path IJKST, which has not been processed, to the total number of executions is equal to or greater than the path selection threshold value (5%) that was set by the software developer in an arbitrary manner (step S502).

The parallel execution control unit 131 judges that the ratio (5%) of the number of executions of path IJKST is equal to or greater than the path selection threshold value (5%) (“Y” in step S502). The parallel execution control unit 131 adds the path IJKST to the parallel execution path list (step S503), and returns to step S501.

The parallel execution control unit 131 judges whether or not all of paths IJQ, IJKL, IJKST, and IX were processed in step S502 (step S501).

The parallel execution control unit 131 judges in the negative since path IX was not processed in step S502 (“N” in step S501). The parallel execution control unit 131 judges, based on the execution history information 301 and the total execution number information 302 stored in the memory 300, whether or not the ratio (3%) of the number of executions of path IX, which has not been processed, to the total number of executions is equal to or greater than the path selection threshold value (5%) that was set by the software developer in an arbitrary manner (step S502).

The parallel execution control unit 131 judges that the ratio (3%) of the number of executions of path IJKST is not equal to or greater than the path selection threshold value (5%) (“N” in step S502). The parallel execution control unit 131 returns to step S501.

The parallel execution control unit 131 judges whether or not all of paths IJQ, IJKL, IJKST, and IX were processed in step S502 (step S501).

The parallel execution control unit 131 judges in the positive since all of paths IJQ, IJKL, IJKST, and IX were processed in step S502 (“Y” in step S501), and the process ends.

After the process is executed as described above, paths IJQ, IJKL and IJKST have been registered with the parallel execution path list.

<Assignment of Processor Elements>

In the following, the processor element assignment process performed by the parallel execution control unit 131 will be described with reference to the flowchart shown in FIG. 6.

In the following description, it is presumed that paths IJQ, IJKL and IJKST are registered with the parallel execution path list, and that the number of processor elements that can be used on the target computer is “3”.

The parallel execution control unit 131 obtains information indicating the number (3) of processor elements that can be used on the target computer (step S601).

The parallel execution control unit 131 assigns a processor element to the compensation path code 132, and adds a compensation path to an execution path list (step S602).

The parallel execution control unit 131 judges whether or not the number (1) of paths to which processor elements have been assigned is equal to the number (3) of processor elements that can be used on the target computer (step S603).

The parallel execution control unit 131 judges that the number (1) of paths to which processor elements have been assigned is not equal to the number (3) of processor elements that can be used on the target computer (“N” in step S603). The parallel execution control unit 131 assigns a processor element to a specific path code corresponding to path IJQ that is the starting path of the parallel execution path list, and deletes, from the parallel execution path list, the path IJQ corresponding to the specific path code to which the processor element was assigned (step S604).

The parallel execution control unit 131 adds, to the execution path list, the path IJQ that corresponds to the specific path code to which the processor element was assigned (step S605).

The parallel execution control unit 131 judges whether or not it is true that the parallel execution path list does not contain a path (step S606).

The parallel execution control unit 131 judges that it is not true since the parallel execution path list contains paths IJKL and IJKST (“N” in step S606). The parallel execution control unit 131 returns to step S603.

The parallel execution control unit 131 judges whether or not the number (2) of paths to which processor elements have been assigned is equal to the number (3) of processor elements that can be used on the target computer (step S603).

The parallel execution control unit 131 judges that the number (2) of paths to which processor elements have been assigned is not equal to the number (3) of processor elements that can be used on the target computer (“N” in step S603). The parallel execution control unit 131 assigns a processor element to a specific path code corresponding to path IJKL that is the starting path of the parallel execution path list, and deletes, from the parallel execution path list, the path IJKL corresponding to the specific path code to which the processor element was assigned (step S604).

The parallel execution control unit 131 adds, to the execution path list, the path IJKL that corresponds to the specific path code to which the processor element was assigned (step S605).

The parallel execution control unit 131 judges whether or not it is true that the parallel execution path list does not contain a path (step S606).

The parallel execution control unit 131 judges that it is not true since the parallel execution path list contains path IJKST (“N” in step S606). The parallel execution control unit 131 returns to step S603.

The parallel execution control unit 131 judges whether or not the number (3) of paths to which processor elements have been assigned is equal to the number (3) of processor elements that can be used on the target computer (step S603).

The parallel execution control unit 131 judges that the number (3) of paths to which processor elements have been assigned is equal to the number (3) of processor elements that can be used on the target computer (“Y” in step S603). The parallel execution control unit 131 goes to step S607.

The parallel execution control unit 131 resets the number of executions of each path indicated by the execution history information 301 and the total number of executions indicated by the total execution number information 302 (step S607).

The parallel execution control unit 131 executes the codes (the compensation path code 132 and specific path codes corresponding to paths IJQ and IJKL) that correspond to all the paths contained in the execution path list (step S608).

<Operation of History Update Code 407>

The following will describe the history update process in which the history update code 407 contained in the compensation path code 132 updates the execution history information 301 and the total execution number information 302, with reference to the flowchart shown in FIG. 7.

In the following description, it is presumed that values “1”, “2”, “3”, “4”, and “6” are registered as the branch instruction identification information 303, that the number of executions of path IJKST indicated by the execution history information 301 stored in the memory 300 is “29”, and that the total number of executions indicated by the total execution number information 302 is “98”.

The history update code 407 obtains the branch instruction identification information 303 (“1”, “2”, “3”, “4”, and “6”) stored in the memory 300 (step S701).

The history update code 407 identifies path IJKST that was actually executed, by referring to the obtained branch instruction identification information 303 (“1”, “2”, “3,”, “4”, and “6”) (step S702).

The history update code 407 increments, by “1”, the number (29) of executions of path IJKST that is identified by one of the identifiers included in the execution history information 301 stored in the memory 300, so that the number becomes “30” (step S703).

The history update code 407 increments the total number (98) of executions indicated by the total execution number information 302 by “1”, so that the total number becomes “99” (step S704).

<Operation of History Update Code 420>

The following will describe the history update process in which the history update code 420 contained in each specific path code updates the execution history information 301 and the total execution number information 302, with reference to the flowchart shown in FIG. 8.

In the following description, it is presumed that the second PE 312 has been assigned to the first path code that is the specific path code corresponding to path IJQ, that the path condition judgment code 409 has judged whether or not a condition for executing path IJQ is satisfied, that the number of executions of path IJQ indicated by the execution history information 301 stored in the memory 300 is “49”, and that the total number of executions indicated by the total execution number information 302 is “99”.

The history update code 420 increments, by “1”, the number (49) of executions of path IJQ corresponding to the own specific path code, the path IJQ being identified by one of the identifiers included in the execution history information 301, so that the number becomes “50” (step S801).

The history update code 420 increments the total number (99) of executions indicated by the total execution number information 302 by “1”, so that the total number becomes “100” (step S802).

<Review of Assignment of Processor Elements>

The following will describe the process of reviewing the specific path codes that are to be executed in parallel with the compensation path code 132, with reference to the flowchart shown in FIG. 9.

In the following description, it is presumed that the compensation path and paths IJQ and IJKL are registered with the execution path list, that the number of paths to which processor elements have been assigned is “3”, and that the number of processor elements that can be used on the target computer is “3”.

In the following description, it is also presumed that the numbers of executions of the paths indicated by the execution history information 301 stored in the memory 300 are: 50 with path IJQ; 20 with path IJKL; 30 with path IJKST; and 0 with path IX, that the total number of executions indicated by the total execution number information 302 is 100, and that the path selection threshold value that has been specified by the software developer in an arbitrary manner is “30%”.

The parallel execution control unit 131 judges whether or not the total number (100) of executions indicated by the total execution number information 302 stored in the memory 300 is equal to “100” (step S901).

The parallel execution control unit 131 judges that the total number of executions is equal to “100” (“Y” in step S901). The parallel execution control unit 131 performs the path selection process in accordance with the flowchart shown in FIG. 5 to select paths corresponding to specific path codes that are to be executed in parallel with the compensation path code 132 (step S902). As a result of the path selection process, paths IJQ and IJKST are registered with the parallel execution path list.

The parallel execution control unit 131 judges whether or not there are paths that are contained in the execution path list (the compensation path and paths IJQ and IJKL) and are not contained in the parallel execution path list (paths IJQ and IJKST) (step S903).

The parallel execution control unit 131 judges in the positive since path IJKL is contained in the execution path list, but not in the parallel execution path list (“Y” in step S903). The parallel execution control unit 131 cancels the assignment of a processor element to the specific path code corresponding to path IJKL, and deletes path IJKL from the execution path list (step S904). As a result of this step, the number of paths to which processor elements have been assigned is “2”.

The parallel execution control unit 131 judges whether or not there are paths that are contained in the parallel execution path list (paths IJQ and IJKST) and are not contained in the execution path list (the compensation path and path IJQ) (step S905).

The parallel execution control unit 131 judges in the positive since path IJKST is contained in the parallel execution path list, but not in the execution path list (“Y” in step S905). The parallel execution control unit 131 deletes paths other than path IJKST, from the parallel execution path list (step S906).

The parallel execution control unit 131 obtains information indicating the number (3) of processor elements that can be used on the target computer (step S907).

The parallel execution control unit 131 judges whether or not the number (2) of paths to which processor elements have been assigned is equal to the number (3) of processor elements that can be used on the target computer (step S908).

The parallel execution control unit 131 judges in the negative since the number (2) of paths to which processor elements have been assigned is not equal to the number (3) of processor elements that can be used on the target computer (“N” in step S908). The parallel execution control unit 131 assigns a processor element to a specific path code corresponding to path IJKST being the starting path of the parallel execution path list, and deletes, from the parallel execution path list, path IJKST corresponding to the specific path code to which the processor element was assigned (step S909).

The parallel execution control unit 131 adds, to the execution path list, path IJKST that corresponds to the specific path code to which the processor element was assigned (step S910).

The parallel execution control unit 131 judges whether or not it is true that the parallel execution path list does not contain a path (step S911).

The parallel execution control unit 131 judges in the positive since it is true that the parallel execution path list does not contain a path (“Y” in step S911). The parallel execution control unit 131 resets the number of executions of each path indicated by the execution history information 301 and the total number of executions indicated by the total execution number information 302 (step S912).

The parallel execution control unit 131 executes the codes (the compensation path code 132 and specific path codes corresponding to paths IJQ and IJKST) that correspond to all the paths contained in the execution path list (step S913).

### Embodiment 2

### <Overview>

In the process of reviewing the specific path codes to be executed in parallel with each other in Embodiment 1, the execution program 130 cancels the assignment of processor elements to specific path codes that, among the specific path codes that have been executed in parallel with the compensation path code, correspond to paths whose ratio of the number of executions to the total number of executions is smaller than the path selection threshold value (hereinafter such paths are referred to as restriction paths), assigns processor elements to specific path codes that have not been executed in parallel and whose ratio of the number of executions to the total number of executions is greater than the path selection threshold value, depending on the number of processor elements that can be used on the target hardware, and causes the specific path codes to be executed in parallel with the compensation path code. The structure enables the processor elements to be used efficiently and the processing speed to be increased.

The execution program 1000 of Embodiment 2 has in common with the execution program 130 of Embodiment 1 in that, in the process of reviewing the specific path codes to be executed in parallel with each other, it cancels the assignment of processor elements to the specific path codes corresponding to the restriction paths, to use the processor elements efficiently.

The execution program 1000 of Embodiment 2 further assigns a processor element to a pair of specific path codes respectively corresponding to a continued execution path and a restriction path whose execution times in sum are smaller than the execution time of the compensation path code, where the continued execution path is a path that corresponds to a specific path code that has been executed in parallel with the compensation path code, and whose ratio of the number of executions to the total number of executions is greater than the path selection threshold value. The execution program 1000 of Embodiment 2 causes the pair of specific path codes to be executed in parallel with the compensation path code.

The processor element assigned to the pair of specific path codes normally executes the continued execution path having a high execution frequency; and when the continued execution path does not satisfy the condition for the execution, the processor element executes the restriction path having a low execution frequency. With this structure, it is possible to speed up the process as is the case with Embodiment 1 when the continued execution path satisfies the condition for the execution.

Furthermore, it is possible to speed up the process even when the continued execution path does not satisfy the condition for the execution and the restriction path satisfies the condition for the execution, since the sum of the execution times of specific path codes respectively corresponding to the continued execution path and the restriction path is smaller than the execution time of the compensation path code,

<Program Generating Device>

A program generating device for generating an execution program 1000 of the program of Embodiment 2 will be described.

Basically, the structure of the program generating device of Embodiment 2 has the same structure as the program generating device 100 of Embodiment 1, but differs therefrom in that the code converting unit of Embodiment 2 generates an execution program 1000 that contains specific path codes and a parallel execution control code that are different from those contained in the execution program 130 generated by the code converting unit 103 of Embodiment 1.

It should be noted here that the data input to the program generating device of Embodiment 2 and the operation of the program generating device of Embodiment 2 are the same as those of the program generating device 100 of Embodiment 1, except that the execution program 1000 is generated, and description thereof is omitted.

<Execution Program 1000>

The following is an explanation of the execution program 1000 of Embodiment 2.

<Structure>

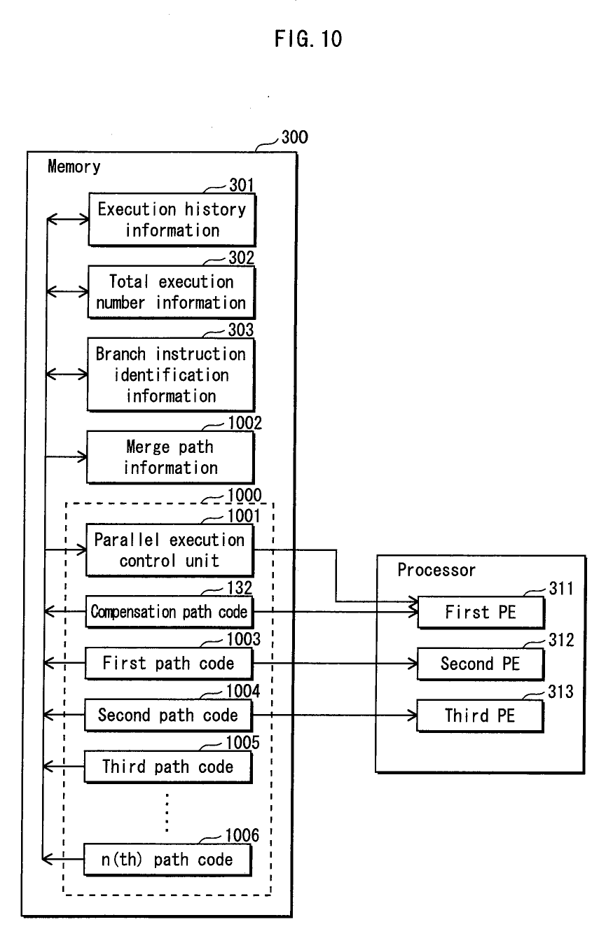

The structure of the execution program 1000 of Embodiment 2 will be described with reference to FIG. 10.

As shown in FIG. 10, the execution program 1000 is stored in the memory 300 provided in the target hardware, and includes the compensation path code 132, a parallel execution control unit 1001, a first path code 1003, a second path code 1004, a third path code 1005, . . . , and n^{th} path code 1006.

Description of the compensation path code 132 is omitted here since it is the same as in Embodiment 1.

The parallel execution control unit 1001 basically has the same function as the parallel execution control unit 131 of Embodiment 1, but has a different function therefrom when reviewing the specific path codes.

The parallel execution control unit 1001 has a function to perform a control to detect, from among the paths corresponding to the specific path codes executed in parallel, restriction paths whose values of the ratio of the number of executions to the total number of executions (hereinafter the ratio is referred to as “execution ratio”) are smaller than the path selection threshold value, cancel the assignment of processor elements to the specific path codes corresponding to the detected restriction paths, and determine to assign a processor element to a pair of (i) a specific path code corresponding to a continued execution path whose value of the execution ratio is greater than the path selection threshold value, and (ii) a specific path code corresponding to one of the restriction paths from which the assignment of processor elements was cancelled.

More specifically, the parallel execution control unit 1001 determines to assign a processor element to a pair of a specific path code corresponding to a continued execution path and a specific path code corresponding to a restriction path when (a) the restriction path has a value of the execution ratio that is equal to or smaller than the path selection threshold value and is equal to or greater than a predetermined value (for example, the predetermined value is a value obtained by multiplying the path selection threshold value by “0.7”), and (b) a sum of (b-1) an execution time of the specific path code corresponding to the continued execution path and (b-2) an execution time of the specific path code corresponding to the restriction path is smaller than an execution time of the compensation path code. In this case, the parallel execution control unit 1001 registers identifiers of the continued execution path and the restriction path, with merge path information 1002 stored in the memory 300.

The reason for setting the condition, where the restriction path should have a value of the execution ratio that is equal to or smaller than the path selection threshold value and is equal to or greater than a predetermined value (for example, the predetermined value is a value obtained by multiplying the path selection threshold value by “0.7”), is as follows. That is to say, when the restriction path has a value of the execution ratio that is excessively smaller than the path selection threshold value, the possibility that the specific path code corresponding to the restriction path is executed is extremely low even if the parallel execution control unit 1001 assigns a processor element to the pair of the specific path code corresponding to the continued execution path and the specific path code corresponding to the restriction path.

In the present embodiment, it is presumed that the predetermined value that is smaller than the path selection threshold value is preliminarily specified by the software developer, and that the execution times of the specific path code corresponding to the continued execution path, the specific path code corresponding to the restriction path, and the compensation path code for use are preliminarily obtained by a profiling or the like.

The identifiers described above in the present embodiment are the same as those for identifying each path, included in the execution history information 301. The merge path information 1002 will be described in detail later.

The first path code 1003, second path code 1004, third path code 1005, . . . , and n^{th} path code 1006 are specific path codes that are basically the same as the first path code 133, second path code 134, third path code 135, . . . , and n^{th} path code 136, but differ therefrom in that each specific path code includes a restriction path execution judgment code 1101 and a restriction path execution code 1102, where the restriction path execution judgment code 1101 judges, based on the merge path information 1002 stored in the memory 300 of the target hardware, whether or not to execute the specific path code corresponding to the restriction path, and the restriction path execution code 1102 executes the specific path code corresponding to the restriction path.

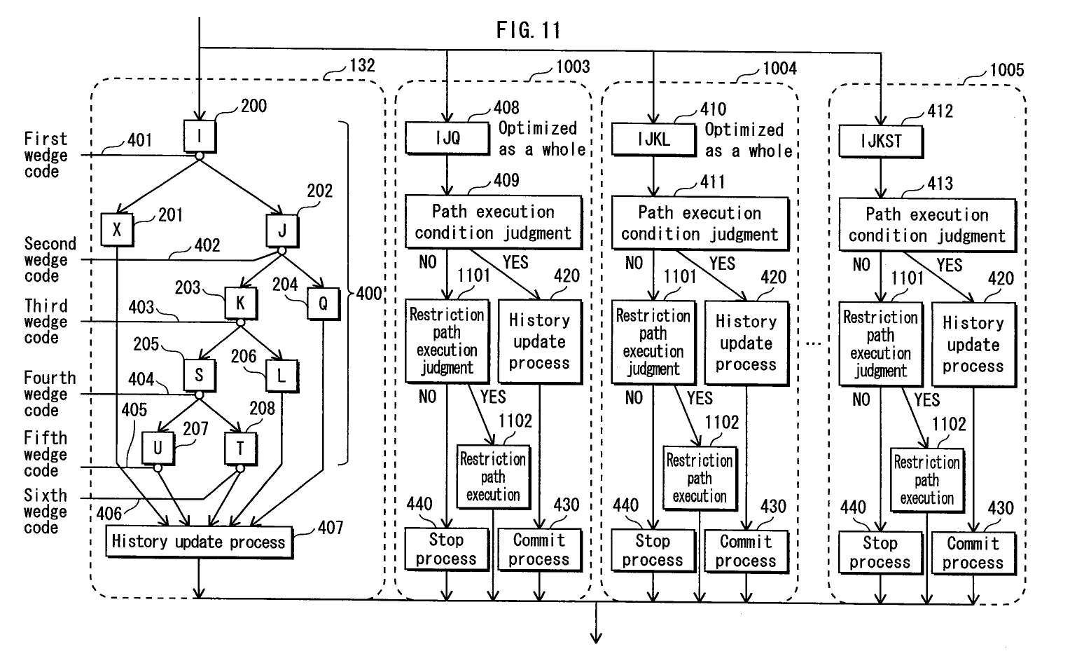

Since, basically, the first path code 1003, second path code 1004, third path code 1005, . . . , and n^{th} path code 1006 have the same structure, in the following detailed description, the first path code 1003 will be used, with reference to FIG. 11.

FIG. 11 shows how the compensation path code 132, the first path code 1003, the second path code 1004, and the third path code 1005, which constitute the partial program of the source program 110 shown in FIG. 2, are assigned with processor elements and are executed in parallel with each other.

As shown in FIG. 11, the first path code 1003 includes the process content code 408, the path condition judgment code 409, the history update code 420, the commit code 430, the stop code 440, a restriction path execution judgment code 1101, and a restriction path execution code 1102.

The codes included in the first path code 1003 is the same as those included in the first path code 133 of Embodiment 1, except for the restriction path execution judgment code 1101 and the restriction path execution code 1102. Thus, description of the codes other than the restriction path execution judgment code 1101 and the restriction path execution code 1102 is omitted.

The restriction path execution judgment code 1101 is a code to be executed when the path condition judgment code 409 judges that a condition is not satisfied, and has a function to judge whether or not there is a restriction path to be executed following the path IJQ.

More specifically, the restriction path execution judgment code 1101 judges that there is a restriction path to be executed, when an identifier of a restriction path corresponding to an identifier of path IJQ is registered with the merge path information 1002 stored in the memory 300.

The restriction path execution code 1102 executes a specific path code corresponding to the restriction path whose identifier corresponds to the identifier of path IJQ, based on the merge path information 1002 stored in the memory 300, when the restriction path execution judgment code 1101 judges that there is a restriction path to be executed.

<Data>

The merge path information 1002 includes identifiers for identifying continued execution paths, and includes identifiers for identifying restriction paths that are to be executed following the continued execution paths.

When the parallel execution control unit 1001 determines to assign a processor element to a pair of (i) a specific path code corresponding to a continued execution path, and (ii) a specific path code corresponding to a restriction path, data is added to the merge path information 1002.

<Operation>

<Review of Assignment of Processor Elements>

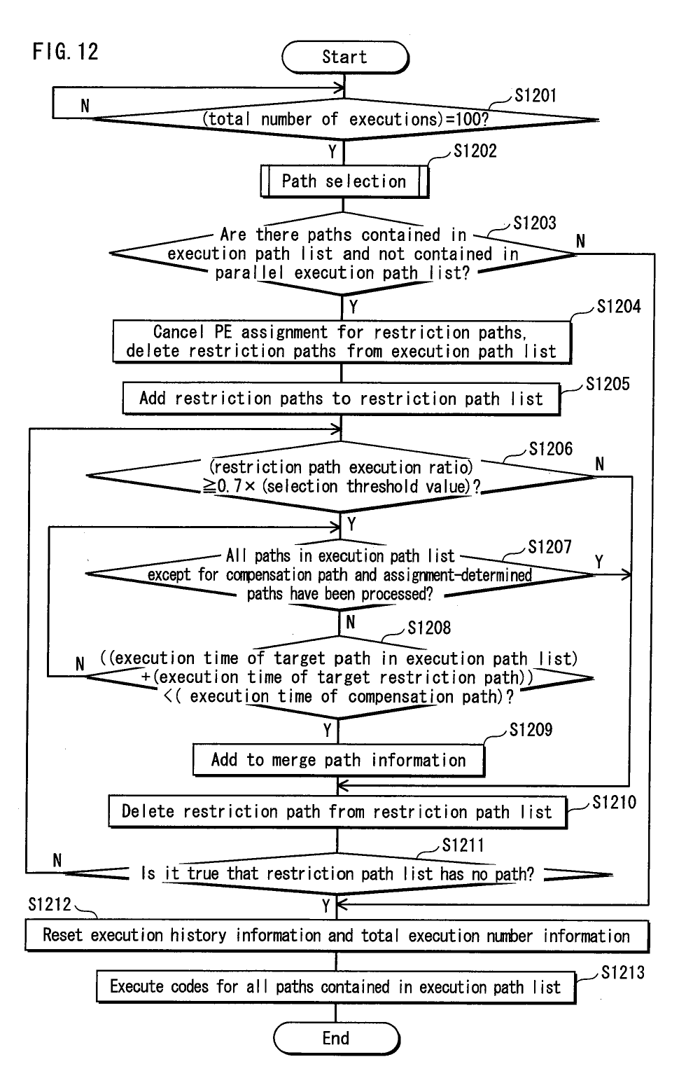

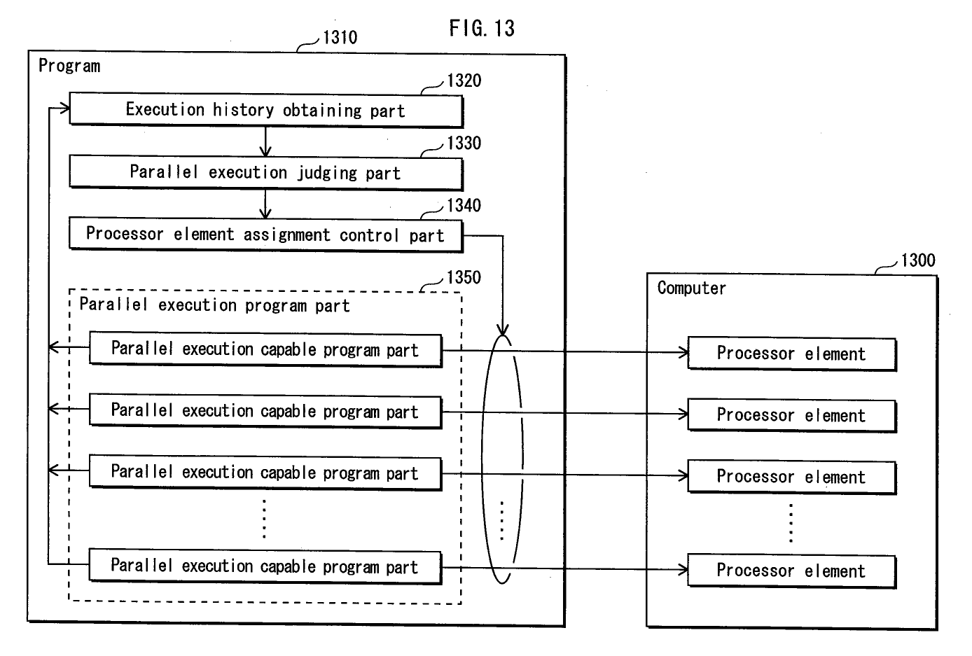

The following will describe the process of reviewing the specific path codes that are to be executed in parallel with the compensation path code 132, with reference to the flowchart shown in FIG. 12.

Description of steps S1201 and S1202 is omitted since they are the same as steps S901 and S902 shown in the flowchart of FIG. 9.

The parallel execution control unit 1001 judges whether or not there are paths that are contained in the execution path list and are not contained in the parallel execution path list (step S1203).

When there are paths that are contained in the execution path list and are not contained in the parallel execution path list (“Y” in step S1203), the parallel execution control unit 1001 cancels the assignment of processor elements to specific path codes corresponding to all the detected restriction paths, and delete all the detected restriction paths from the execution path list (step S1204). The parallel execution control unit 1001 then goes to step S1205.

When there are no such paths that are contained in the execution path list and are not contained in the parallel execution path list (“N” in step S1203), the parallel execution control unit 1001 goes to step S1212.

The parallel execution control unit 1001 adds all the detected restriction paths to the restriction path list (step S1205).

The parallel execution control unit 1001 judges whether or not the execution ratio of a restriction path is equal to or greater than the predetermined value (for example, the predetermined value is a value obtained by multiplying the path selection threshold value by “0.7”) and is equal to or smaller than the path selection threshold value (step S1206).

When it judges that the execution ratio of the restriction path is equal to or greater than the predetermined value and is equal to or smaller than the path selection threshold value (“Y” in step S1206), the parallel execution control unit 1001 judges whether or not all paths, except for the compensation path and paths for which it has been determined that a processor element is assigned to each pair of a specific path code corresponding to one of them and a restriction path, in the execution path list have been subjected to the process of step S1208, which will be described later (step S1207).

When it judges that not all paths in the execution path list have been subjected to the process (“N” in step S1207), the parallel execution control unit 1001 judges whether or not the sum of the execution time of the path in question in the execution path list and the execution time of the restriction path in question is smaller than the execution time of the compensation path (step S1208).

When it judges that the sum of the execution times of the path in question and the restriction path is equal to or greater than the execution time of the compensation path (“N” in step S1208), the parallel execution control unit 1001 returns to step S1207.

When it judges that the sum of the execution times of the path in question and the restriction path is smaller than the execution time of the compensation path (“Y” in step S1208), the parallel execution control unit 1001 registers identifiers of the restriction path and the path in question in the execution path list, with the merge path information 1002 stored in the memory 300 (step S1209).

The parallel execution control unit 1001 deletes the restriction path in question from the restriction path list (step S1210).

The parallel execution control unit 1001 judges whether or not it is true that the restriction path list has no path (step S1211).

When it judges that the restriction path list has one or more paths (“N” in step S1211), the parallel execution control unit 1001 returns to step S1206.

When it judges that the restriction path list has no path (“Y” in step S1211), the parallel execution control unit 1001 resets the number of executions of each path indicated by the execution history information 301 and the total number of executions indicated by the total execution number information 302 (step S1212).

The parallel execution control unit 1001 executes the codes (the compensation path code 132 and specific path codes corresponding to the paths contained in the execution path list) for all paths contained in the execution path list (step S1213).

When it judges that the execution ratio of the restriction path is smaller than the predetermined value that is smaller than the path selection threshold value (“N” in step S1206), or when it judges that all paths in the execution path list have been subjected to the process (“Y” in step S1207), the parallel execution control unit 1001 goes to step S1210.

<Operation with Specific Example>

The operation of the execution program 1000 will be described in more detail using, as an example, the part of the source program 110 shown in FIG. 2.

<Review of Assignment of Processor Elements>

The following will describe the process of reviewing the specific path codes that are to be executed in parallel with the compensation path code 132, with reference to the flowchart shown in FIG. 12.

In the following description, it is presumed that the compensation path and paths IJQ and IJKL are registered with the execution path list, that the number of paths to which processor elements have been assigned is “3”, and that the number of processor elements that can be used is “3”.

In the following description, it is also presumed that the numbers of executions of the paths indicated by the execution history information 301 stored in the memory 300 are: 70 with path IJQ; 20 with path IJKL; 10 with path IJKST; and 0 with path IX, and that the total number of executions indicated by the total execution number information 302 is “100”.

In the following description, it is also presumed that the path selection threshold value that has been specified by the software developer in an arbitrary manner is “30%”, and that the predetermined value that is smaller than the path selection threshold value is “20%”.

In the following description, it is also presumed that the sum of the execution times of paths IJQ and IJKL is smaller than the execution time of the compensation path.

The parallel execution control unit 1001 judges whether or not the total number (100) of executions indicated by the total execution number information 302 stored in the memory 300 is equal to “100” (step S1201).

The parallel execution control unit 1001 judges that the total number of executions is equal to “100” (“Y” in step S1201). The parallel execution control unit 1001 performs the path selection process in accordance with the flowchart shown in FIG. 5 to select paths corresponding to specific path codes that are to be executed in parallel with the compensation path code 132 (step S1202). As a result of the path selection process, path IJQ is registered with the parallel execution path list.

The parallel execution control unit 1001 judges whether or not there are paths that are contained in the execution path list (the compensation path and paths IJQ and IJKL) and are not contained in the parallel execution path list (path IJQ) (step S1203).

The parallel execution control unit 1001 judges that there are paths (path IJKL) that are contained in the execution path list and are not contained in the parallel execution path list (“Y” in step S1203). The parallel execution control unit 1001 cancels the assignment of a processor element to the specific path code corresponding to the restriction path IJKL, and deletes the restriction path IJKL from the execution path list (step S1204).

The parallel execution control unit 1001 adds the restriction path IJKL to the restriction path list (step S1205).

The parallel execution control unit 1001 judges whether or not the execution ratio (20%) of the restriction path IJKL is equal to or greater than the predetermined value (20%) and is equal to or smaller than the path selection threshold value (step S1206).

The parallel execution control unit 1001 judges that the execution ratio of the restriction path is equal to or greater than the predetermined value and is equal to or smaller than the path selection threshold value (“Y” in step S1206). The parallel execution control unit 1001 judges whether or not all paths (path IJQ), except for the compensation path and paths for which it has been determined that a processor element is assigned to each pair of a specific path code corresponding to one of them and a restriction path, in the execution path list have been subjected to the process of step S1208 (step S1207).

The parallel execution control unit 1001 judges in the negative since path IJQ has not been subjected to the process (“N” in step S1207). The parallel execution control unit 1001 judges whether or not the sum of the execution time of the path IJQ in the execution path list and the execution time of the restriction path IJKL is smaller than the execution time of the compensation path (step S1208).

The parallel execution control unit 1001 judges that the sum of the execution times of the path IJQ and the restriction path IJKL is smaller than the execution time of the compensation path (“Y” in step S1208). The parallel execution control unit 1001 registers identifiers of the restriction path IJKL and the path IJQ in the execution path list, with the merge path information 1002 stored in the memory 300 (step S1209).

The parallel execution control unit 1001 deletes the restriction path IJKL from the restriction path list (step S1210).

The parallel execution control unit 1001 judges whether or not it is true that the restriction path list has no path (step S1211).

The parallel execution control unit 1001 judges that the restriction path list has no path (“Y” in step S1211). The parallel execution control unit 1001 resets the number of executions of each path indicated by the execution history information 301 and the total number of executions indicated by the total execution number information 302 (step S1212).

The parallel execution control unit 1001 executes the codes (the compensation path code 132 and the specific path code corresponding to the path IJQ) for all paths contained in the execution path list (step S1213).

### <Supplementary Notes>

Up to now, the program of the present invention has been described through several embodiments. However, the present invention is not limited to these embodiments, but may be modified as follows, for example.

(1) The parallel execution control unit 131 of Embodiment 1 and the parallel execution control unit 1001 of Embodiment 2 may be processed by another hardware that is different from the target hardware that executes the compensation path code 132 and each specific path code.

(2) In the above-described embodiments, the compensation path code 132 includes the process content code 400 being a code sequence generated by converting the source program itself into an execution format. Not limited to this, however, the process content code 400 may be a program generated by removing instruction sequences contained in the paths that correspond to the specific path codes, from the source program.

(3) In the above-described embodiments, the same value is used as (a) the path selection threshold value that is used in the path selection process to select specific path codes for the parallel execution, as indicated in the flowchart shown in FIG. 5 and (b) the path selection threshold value that is used to judge whether or not to cancel the assignment of processor elements in the process of reviewing the assignment of processor elements, as indicated in the flowchart shown in FIG. 9. However, not limited to this, different values may be used as the path selection threshold value, respectively in these processes. For example, the path selection threshold value that is used in the path selection process to select specific path codes for the parallel execution, as indicated in the flowchart shown in FIG. 5 may be set to “30%”, and the path selection threshold value that is used to judge whether or not to cancel the assignment of processor elements in the process of reviewing the assignment of processor elements, as indicated in the flowchart shown in FIG. 9 may be set to “20%”. With such an arrangement, it is possible to prevent the assignment and the cancellation of the assignment of processor elements from happening frequently when, for example, the execution ratio of each specific path code changes frequently around the path selection threshold value.

(4) In Embodiment 1, when the ratio of the number of executions of each specific path code to the total number of executions is smaller than the path selection threshold value in the process of reviewing the assignment of processor elements, the assignment of processor elements is cancelled. However, not limited to this, when the ratio is smaller than the path selection threshold value, only the execution of each specific path code may be stopped, but the assignment of processor elements may be maintained. With this arrangement, when the ratio of the number of executions of the specific path code, which was stopped to be executed, to the total number of executions becomes greater than the path selection threshold value as it was before, the process of assigning a processor element to the specific path code can be omitted, and thus the execution can be started at an earlier timing.

(5) In the above-described Embodiments 1 and 2, each time the total number of actual executions of a path reaches “100”, the assignment of a processor element to the specific path code corresponding to the path is reviewed. However, not limited to this, the review may be performed, for example, based on the cumulative number of executions, without resetting the number of executions of paths corresponding to the specific path codes. As another example, each time the total number of actual executions of a path reaches “200”, the assignment of a processor element to the specific path code corresponding to the path may be reviewed.

(6) In the above-described Embodiments land 2, the first to sixth wedge codes 401-406 are provided in the compensation path code 132 for the purpose of identifying the executed paths completely. However, not limited to this, for example, only the first to fourth wedge codes 401-404 may be provided by the specification of the software developer so that only main paths with high execution frequency can be identified.

(7) In Embodiment 1, the branch instruction identification information 303 is presumed to be numerals, such as “1”, output from the wedge codes. Not limited to this, however, the branch instruction identification information 303 may be preliminarily embedded binary data composed of as many bits as the number of provided wedge codes, and when a wedge code is executed, a predetermined bit corresponding to the executed wedge code may be set to “1”.

(8) In the process of reviewing the assignment of processor elements in Embodiment 2, one processor element is assigned to execute a restriction path and a continued execution path. However, when a path, which has not been executed in parallel, is selected in the path selection process, a processor element may be assigned to a specific path code corresponding to the selected path depending on the number of processor elements that can be used on the target hardware, as is the case with Embodiment 1.

(9) In the process of reviewing the assignment of processor elements in Embodiment 2, one processor element is assigned to execute a restriction path and a continued execution path. However, the same process may be performed in the processor element assignment process when the execution of the execution program 1000 is started.

(10) In the program of Embodiment 1, the assignment of processor elements to the compensation path code and the selected specific path codes is achieved via an OS (Operating System) or the like. However, it may be achieved without use of the OS or the like. For example, the program of Embodiment 1 may have a function to assign processor elements.

(11) In the program generating device 100, the code generation threshold value is specified by the software developer preliminarily. However, not limited to this, the code generation threshold value may be a preliminarily set fixed value, or may be a variable that is obtained by a predetermined algorithm.

(12) In Embodiment 2, one processor element is assigned to a pair of specific path codes that respectively correspond to a restriction path and a continued execution path, and when the specific path code corresponding to the continued execution path is not executed, the specific path code corresponding to the restriction path is executed.

With this structure, it is possible to use the processor elements efficiently by assigning one processor element to a pair of specific path codes that respectively correspond to a continued execution path with a high execution frequency and a restriction path with a low execution frequency. Also, when one of the specific path codes is executed, it can be executed at a high speed.

However, not limited to a pair of specific path codes that respectively correspond to a restriction path and a continued execution path, one processor element may be assigned to a pair of specific path codes that correspond to restriction paths, or may be assigned to a pair of specific path codes that correspond to continued execution paths.

Further, not limited to two specific path codes, one processor element may be assigned to three or more specific path codes.

It should be noted here that in any of the above-mentioned cases, as is the case with Embodiment 2, it is required that the specific path codes, to which processor elements have been assigned, are executed in the order from the highest execution frequency, and that the sum of the execution times of the plurality of specific path codes, to which one processor element has been assigned, is smaller than the execution time of the compensation path code.

This structure makes it possible to speed up the process in which specific path codes, to which processor elements have been assigned, are executed.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. A program for execution by a computer that includes a plurality of processor elements, the program comprising:
a parallel execution program part to assign the plurality of processor elements one-to-one to a plurality of program parts so that the plurality of program parts are executed in parallel with each other;
an execution history obtaining part to obtain and hold an execution history of each of the plurality of program parts;
a parallel execution judgment part to judge whether or not to execute the plurality of program parts in parallel with each other, in accordance with the obtained execution history; and
a processor element assignment control part to perform a control to determine whether to assign the plurality of processor elements to the plurality of program parts, depending on a result of the judgment made by the parallel execution judgment part.

2. The program of claim 1, wherein
the parallel execution program part further includes:
a first program part that includes a branch instruction and a plurality of execution paths caused by the branch instruction; and
a second program part that is repeatedly executed in parallel with the first program part, and includes (i) a block that has a process content that is equivalent with a process content of apart of a certain execution path, among the plurality of execution paths, that does not include the branch instruction, the block of the second program part having a smaller execution time than the part of the certain execution path, (ii) a block that judges whether or not a condition for executing the certain execution path is satisfied, and (iii) a block that controls, when it is judged that the condition is satisfied with respect to a repetitive execution unit, to process a next repetitive execution unit together with the first program part, wherein
the execution history obtaining part is included in at least one of the first program part and the second program part.

3. The program of claim 2, wherein
the execution history obtaining part counts a number of executions of the certain execution path and holds information indicating the number of executions of the certain execution path as the execution history, and
the parallel execution judgment part judges not to execute the second program part and the first program part in parallel with each other when the number of executions of the certain execution path indicated by the execution history is smaller than a predetermined threshold value.

4. The program of claim 2 further comprising
a third program part that is repeatedly executed in parallel with the first program part, and includes (i) a block that has a process content that is equivalent with a process content of a part of a second execution path that is other than a first execution path being the certain execution path, among the plurality of execution paths that does not include the branch instruction, the block of the third program part having a smaller execution time than the part of the second execution path, (ii) a block that judges whether or not a condition for executing the second execution path is satisfied, and (iii) a block that controls, when it is judged that the condition is satisfied with respect to a repetitive execution unit, to process a next repetitive execution unit together with the first program part, wherein
when the parallel execution judgment part judges not to execute the second program part and the first program part in parallel with each other, the parallel execution judgment part repeatedly judges, in accordance with the obtained execution history, whether or not to execute the third program part and the first program part in parallel with each other, and
the processor element assignment control part assigns a first processor element to the first program part, and performs a control to determine whether to assign a second processor element to the third program part, and execute the first program part and the third program part in parallel with each other, depending on a result of the judgment made by the parallel execution judgment part on whether or not to execute the third program part and the first program part in parallel with each other.

5. The program of claim 2, wherein
the execution history obtaining part counts a number of executions of the certain execution path and holds information indicating the number of executions of the certain execution path as the execution history, and
the parallel execution judgment part judges not to execute the second program part and the first program part in parallel with each other when the processor element assignment control part performed a control to determine to assign a second processor element to the second program part and execute the second program part and the first program part in parallel with each other, and when the number of executions of the certain execution path indicated by the execution history is smaller than a predetermined threshold value, and
the processor element assignment control part performs a control to stop executing the second program part and the first program part in parallel with each other.

6. The program of claim 2, wherein
the execution history obtaining part counts a number of executions of the certain execution path and holds information indicating the number of executions of the certain execution path as the execution history, and
the parallel execution judgment part judges not to execute the second program part and the first program part in parallel with each other when the processor element assignment control part performed a control to determine to assign a second processor element to the second program part and execute the second program part and the first program part in parallel with each other, and when the number of executions of the certain execution path indicated by the execution history is smaller than a predetermined threshold value, and
the processor element assignment control part performs a control to cancel assignment of the second processor element to the second program part.

7. The program of claim 6 further comprising:
a third program part that is repeatedly executed in parallel with the first program part, and includes (i) a block that has a process content that is equivalent with a process content of a part of a second execution path that is other than the certain execution path, among the plurality of execution paths that does not include the branch instruction, the block of the third program part having a smaller execution time than the part of the second execution path, (ii) a block that judges whether or not a condition for executing the second execution path is satisfied, and (iii) a block that controls, when it is judged that the condition is satisfied with respect to a repetitive execution unit, to process a next repetitive execution unit together with the first program part; and
another execution history obtaining part that is included in the third program part and obtains and holds an execution history of the second execution path, wherein
when the parallel execution judgment part judges not to execute the second program part and the first program part in parallel with each other, the parallel execution judgment part repeatedly judges, in accordance with the execution history held by the another execution history obtaining part included in the third program part, whether or not to execute the third program part and the first program part in parallel with each other, and
the processor element assignment control part assigns a first processor element to the first program part, and performs a control to determine whether to assign a second processor element to the third program part, and execute the first program part and the third program part in parallel with each other, depending on a result of the judgment made by the parallel execution judgment part on whether or not to execute the third program part and the first program part in parallel with each other.

8. The program of claim 2 further comprising
an assignment available number obtaining part to obtain information indicating a number of assignable processor elements that can be assigned among the plurality of processor elements of the computer, wherein
the processor element assignment control part further includes
an assignment availability judgment part to count a number of assigned processor elements that have been assigned, and judge whether or not the number of assigned processor elements is smaller than the number of assignable processor elements, and
the processor element assignment control part performs a control to assign a second processor element to the second program part, and execute the first program part and the second program part in parallel with each other when the number of assigned processor elements is smaller than the number of assignable processor elements when the parallel execution judgment part judges to execute the second program part and the first program part in parallel with each other.

9. The program of claim 2 further comprising
an execution history initializing part to initialize the execution history each time the parallel execution judgment part performs the judgment.

10. The program of claim 2 further comprising
a third program part that is repeatedly executed in parallel with the first program part, and includes (i) a first block that has a process content that is equivalent with a process content of a first no-branch part that is part of a first execution path being the certain execution path and does not include the branch instruction, among the plurality of execution paths, the first block of the third program part having a smaller execution time than the first no-branch part, (ii) a block that judges whether or not a condition for executing the first execution path is satisfied, (iii) a second block that has a process content that is equivalent with a process content of a second no-branch part that is part of a second execution path being another certain execution path other than the first execution path and does not include the branch instruction, among the plurality of execution paths, the second block of the third program part having a smaller execution time than the second no-branch part, (iv) a block that controls, when it is judged that the condition for executing the first execution path is satisfied with respect to a repetitive execution unit, to process a next repetitive execution unit together with the first program part, and controls, when it is judged that the condition is not satisfied, to judge whether or not a condition for executing the second execution path is satisfied, and (v) a block that controls, when it is judged that the condition for executing the second execution path is satisfied with respect to a repetitive execution unit, to process a next repetitive execution unit together with the first program part, wherein
the parallel execution judgment part repeatedly judges, in accordance with the obtained execution history, whether or not to execute the third program part and the first program part in parallel with each other, and
the processor element assignment control part assigns a first processor element to the first program part, and performs a control to determine whether to assign a second processor element to the third program part, and execute the first program part and the third program part in parallel with each other, depending on a result of the judgment made by the parallel execution judgment part on whether or not to execute the third program part and the first program part in parallel with each other.

11. The program of claim 10, wherein
when the parallel execution judgment part judges not to execute the second program part and the first program part in parallel with each other, the second execution path included in the third program part is set to be a certain execution path in the second program part.

12. The program of claim 10, wherein
the execution history obtaining part is included in the third program part, counts a number of executions of the first execution path, counts a number of executions of the second execution path, and holds the numbers of executions of the first and second execution paths as the execution history, and
the number of executions of the first execution path is greater than the number of executions of the second execution path.

13. A program generation method for generating, based on a source program that includes a branch instruction and a plurality of execution paths caused by the branch instruction, an execution program for execution by a computer that includes a plurality of processor elements, the program generation method comprising the steps of:
generating a first program part of an execution format based on all instructions contained in the plurality of execution paths of the source program, maintaining relationships between the plurality of execution paths;
generating a second program part that is repeatedly executed in parallel with the first program part, and includes (i) a block that has a process content that is equivalent with a process content of a part of a certain execution path, among the plurality of execution paths, that does not include the branch instruction, the block of the second program part having a smaller execution time than the part of the certain execution path, (ii) a block that judges whether or not a condition for executing the certain execution path is satisfied, and (iii) a block that controls, when it is judged that the condition is satisfied with respect to a repetitive execution unit, to process a next repetitive execution unit together with the first program part;
generating an execution history obtaining part that is included in at least one of the first program part and the second program part, and obtains and holds an execution history of each of an execution path;
generating a parallel execution judgment part that judges whether or not to execute the second program part and the first program part in parallel with each other, in accordance with the execution history; and
generating a processor element assignment control part that assigns a first processor element to the first program part, and performs a control to determine whether to assign a second processor element to the second program part, and execute the first program part and the second program part in parallel with each other, depending on a result of the judgment made by the parallel execution judgment part on whether or not to execute the second program part and the first program part in parallel with each other.

14. A program generation device for generating, based on a source program that includes a branch instruction and a plurality of execution paths caused by the branch instruction, an execution program for execution by a computer that includes a plurality of processor elements, the program generation device comprising:
a source program obtaining unit to obtain the source program;
a first program part generating unit to generate a first program part of an execution format based on all instructions contained in the plurality of execution paths of the obtained source program, maintaining relationships between the plurality of execution paths;
a second program part generating unit to generate a second program part that is repeatedly executed in parallel with the first program part, and includes (i) a block that has a process content that is equivalent with a process content of a part of a certain execution path, among the plurality of execution paths, that does not include the branch instruction, the block of the second program part having a smaller execution time than the part of the certain execution path, (ii) a block that judges whether or not a condition for executing the certain execution path is satisfied, and (iii) a block that controls, when it is judged that the condition is satisfied with respect to a repetitive execution unit, to process a next repetitive execution unit together with the first program part;
an execution history obtaining part generating unit to generate an execution history obtaining part that is included in at least one of the first program part and the second program part, and obtains and holds an execution history of each of an execution path;
a parallel execution judgment part generating unit to generate a parallel execution judgment part that judges whether or not to execute the second program part and the first program part in parallel with each other, in accordance with the execution history; and
a processor element assignment control part generating unit to generate a processor element assignment control part that assigns a first processor element to the first program part, and performs a control to determine whether to assign a second processor element to the second program part, and execute the first program part and the second program part in parallel with each other, depending on a result of the judgment made by the parallel execution judgment part on whether or not to execute the second program part and the first program part in parallel with each other.

15. A program execution device for executing the program defined in claim 2, the program execution device comprising:
an obtaining unit to obtaining the program; and
an execution unit that has a plurality of processor elements and is to execute the obtained program by assigning the plurality of processor elements, wherein
upon receiving a request to assign a processor element while executing the program, the execution unit assigns a processor element that is not assigned currently.

16. A computer-readable recording medium on which recorded is a program for execution by a computer that includes a plurality of processor elements, the program including:
a first program part that includes a branch instruction and a plurality of execution paths caused by the branch instruction;
a second program part that is repeatedly executed in parallel with the first program part, and includes (i) a block that has a process content that is equivalent with a process content of apart of a certain execution path, among the plurality of execution paths, that does not include the branch instruction, the block of the second program part having a smaller execution time than the part of the certain execution path, (ii) a block that judges whether or not a condition for executing the certain execution path is satisfied, and (iii) a block that controls, when it is judged that the condition is satisfied with respect to a repetitive execution unit, to process a next repetitive execution unit together with the first program part;
an execution history obtaining part that is included in at least one of the first program part and the second program part, and obtains and holds an execution history of each of an execution path;
a parallel execution judgment part that judges whether or not to execute the second program part and the first program part in parallel with each other, in accordance with the execution history; and
a processor element assignment control part that assigns a first processor element to the first program part, and performs a control to determine whether to assign a second processor element to the second program part, and execute the first program part and the second program part in parallel with each other, depending on a result of the judgment made by the parallel execution judgment part on whether or not to execute the second program part and the first program part in parallel with each other.
